(19) United States
(12) Patent Application Publication
(10) Pub. No.: US 2025/0276284 A1
(43) Pub. Date: Sep. 4, 2025

(54) CATALYST FOR THE SELECTIVE CATALYTIC REDUCTION OF NOX

(71) Applicant: BASF CORPORATION, Florham Park, NJ (US)

(72) Inventors: Claudia ZABEL, Hannover (DE); Susanne STIEBELS, Hannover (DE); Andreas ZEEB, Hannover (DE)

(21) Appl. No.: 18/858,110

(22) PCT Filed: Apr. 21, 2023
(86) PCT No.: PCT/EP2023/060456

§ 371 Date: Oct. 18, 2024

(30) Foreign Application Priority Data
Apr. 22, 2022 (EP) 22169397.1

(51) Int. Cl. B01D 53/94; B01J 6/00; B01J 29/76; B01J 37/02; F01N 3/20

(52) U.S. Cl. CPC B01D 53/9418; B01D 53/9477; B01J 6/00; B01J 29/763; B01J 37/0246; F01N 3/2066; B01D 2255/20738; B01D 2255/2092; B01D 2255/50; B01D 2257/404; B01D 2258/012; F01N 2370/04

(57) ABSTRACT

The present invention relates to a catalyst for the selective catalytic reduction of NOx comprising a substrate having an inlet end, an outlet end, a substrate axial length extending from the inlet end to the outlet end and a plurality of passages defined by internal walls of the substrate extending therethrough; and a coating comprising a zeolitic material, copper and a first non-zeolitic oxidic material comprising iron and aluminum, wherein at least 25 weight-% of the first non-zeolitic oxidic material consists of iron, calculated as Fe2O3.

The present invention relates to a catalyst for the selective catalytic reduction of NOx, a process for preparing a catalyst for the selective catalytic reduction of NOx, a catalyst obtained by said process as well as a use of the catalyst of the present invention.

Selective catalytic reduction catalyst (SCR) and selective catalyst reduction catalyst on filter (SCROF) which are copper based are known in the art and provide good NOx conversion. In this respect, U.S. Pat. No. 9,242,238 B2 discloses a mixed catalyst comprising copper-promoted 8-ring small pore molecular sieve and iron-promoted 8-ring small pore molecular sieve. Further, U.S. Pat. No. 9,352,307 B2 discloses a SCR catalyst comprising a mixture of Cu-CHA and Fe-MFI for improving NOx conversion and U.S. Pat. No. 9,999,877 B2 discloses a mixed zeolite catalyst Cu-CHA/Fe-BEA for the treatment of NOx in gas streams.

However, in view of the more and more stringent regulations in particular for Euro 7, good NOx conversion is not enough and limitation of N₂O emissions becomes very important as well such that there is a need to provide a new catalyst for the selective catalytic reduction of NOx which exhibits great NOx conversion and reduces the nitrous oxide (N₂O) formation.

Therefore, it was an object of the present invention to provide a new catalyst for the selective catalytic reduction of NOx which exhibits great NOx conversion and reduces the nitrous oxide (N₂O) formation. Surprisingly, it was found that the catalyst of the present invention permits to exhibit great NOx conversion and reduce the N₂O over a wide temperature range. Further, said catalyst has improved thermal stability compared to the prior art.

Therefore, the present invention relates to a catalyst for the selective catalytic reduction of NOx comprising
a substrate having an inlet end, an outlet end, a substrate axial length extending from the inlet end to the outlet end and a plurality of passages defined by internal walls of the substrate extending therethrough;
a coating comprising a zeolitic material, copper and a first non-zeolitic oxidic material comprising iron and aluminum, wherein at least 25 weight-% of the first non-zeolitic oxidic material consists of iron, calculated as Fe₂O₃.

Preferably the zeolitic material comprised in the coating has a framework type selected from the group consisting of ABW, ACO, AEI, AEL, AEN, AET, AFG, AFI, AFN, AFO, AFR, AFS, AFT, AFV, AFX, AFY, AHT, ANA, APC, APD, AST, ASV, ATN, ATO, ATS, ATT, ATV, AVL, AWO, AWW, BCT, BEA, BEC, BIK, BOF, BOG, BOZ, BPH, BRE, BSV, CAN, CAS, CDO, CFI, CGF, CGS, CHA,-CHI,-CLO, CON, CSV, CZP, DAC, DDR, DFO, DFT, DOH, DON, EAB, EDI, EEI, EMT, EON, EPI, ERI, ESV, ETR, EUO, *-EWT, EZT, FAR, FAU, FER, FRA, GIS, GIU, GME, GON, GOO, HEU, IFO, IFR,-IFU, IFW, IFY, IHW, IMF, IRN, IRR,-IRY, ISV, ITE, ITG, ITH, *-ITN, ITR, ITT,-ITV, ITW, IWR, IWS, IWV, IWW, JBW, JNT, JOZ, JRY, JSN, JSR, JST, JSW, KFI, LAU, LEV, LIO,-LIT, LOS, LOV, LTA, LTF, LTJ, LTL, LTN, MAR, MAZ, MEI, MEL, MEP, MER, MFI, MFS, MON, MOR, MOZ, *MRE, MSE, MSO, MTF, MTN, MTT, MTW, MVY, MWF, MWW, NAB, NAT, NES, NON, NPO, NPT, NSI, OBW, OFF, OKO, OSI, OSO, OWE,-PAR, PAU, PCR, PHI, PON, POS, PSI, PUN, RHO,-RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, *SFV, SFW, SGT, SIV, SOD, SOF, SOS, SSF, *-SSO, SSY, STF, STI, *STO, STT, STW,-SVR, SVV, SZR, TER, THO, TOL, TON, TSC, TUN, UEI, UFI, UOS, UOV, UOZ, USI, UTL, UWY, VET, VFI, VNI, VSV, WEI,-WEN, YUG, ZON, a mixture of two or more thereof, and a mixed type of two or more thereof, more preferably selected from the group consisting of CHA, AEI, RTH, LEV, DDR, KFI, ERI, AFX, a mixture of two or more thereof and a mixed type of two or more thereof, more preferably selected from the group consisting of CHA, AEI, RTH, AFX, a mixture of two or more thereof and a mixed type of two or more thereof, more preferably selected from the group consisting of CHA and AEI. More preferably the zeolitic material comprised in the coating has a framework type CHA.

Preferably from 95 to 100 weight-%, more preferably from 98 to 100 weight-%, more preferably from 99 to 100 weight-% of the framework structure of the zeolitic material consist of Si, Al, and O.

Preferably in the framework structure of the zeolitic material comprised in the coating, the molar ratio of Si to Al, calculated as molar SiO₂:Al₂O₃, is in the range of from 2:1 to 30:1, more preferably in the range of from 5:1 to 28:1, more preferably in the range of from 8:1 to 26:1. More preferably, the molar ratio of Si to Al, calculated as molar SiO₂:Al₂O₃, is in the range of from 10:1 to 19:1, more preferably in the range of from 12:1 to 18:1. Alternatively, more preferably, the molar ratio of Si to Al, calculated as molar SiO₂:Al₂O₃, is in the range of from 20:1 to 25:1.

Preferably, the zeolitic material comprised in the coating, more preferably which has a framework type CHA, has a mean crystallite size of at least 0.1 micrometer, more preferably in the range of from 0.1 to 3.0 micrometers, more preferably in the range of from 0.3 to 1.5 micrometer , more preferably in the range of from 0.4 to 1.0 micrometer determined via scanning electron microscopy.

Preferably, the amount of copper comprised in the coating, calculated as CuO, is in the range of from 2 to 10 weight-%, more preferably in the range of from 2.5 to 8 weight-%, more preferably in the range of from 3 to 7 weight-%, more preferably in the range of from 3.5 to 6 weight-%, based on the weight of the zeolitic material.

Preferably, the zeolitic material comprised in the coating comprises the copper.

Preferably, the zeolitic material comprises iron, wherein the amount of iron comprised in the zeolitic material, calculated as Fe₂O₃, is more preferably in the range of from 0.1 to 1.5 weight-%, more preferably in the range of from 0.15 to 1.25 weight-%, more preferably in the range of from 0.25 to 1 weight-%, more preferably in the range of from 0.3 to 0.8 weight-%, based on the weight of the zeolitic material.

Preferably, the zeolitic material comprises copper and iron. Preferably, the present invention relates to a catalyst for the selective catalytic reduction of NOx comprising a substrate having an inlet end, an outlet end, a substrate axial length extending from the inlet end to the outlet end and a plurality of passages defined by internal walls of the substrate extending therethrough;
a coating comprising a zeolitic material, copper and a first non-zeolitic oxidic material comprising iron and aluminum, wherein at least 25 weight-% of the first non-zeolitic oxidic material consists of iron, calculated as Fe₂O₃;
wherein copper is comprised in the zeolitic material, the zeolitic material comprising iron.

Alternatively, the zeolitic material preferably is substantially free of iron, more preferably free of iron. In other words, preferably from 0 to 0.001 weight-%, more preferably from 0 to 0.0001 weight-%, of the zeolitic material consists of iron, calculated as Fe₂O₃.

Preferably the coating comprises the zeolitic material at a loading in the range of from 0.25 to 5 g/in³, more preferably in the range of from 0.75 to 3 g/in³, more preferably in the range of from 1 to 2.5 g/in³, more preferably in the range of from 1.25 to 2.2 g/in³.

Preferably the zeolitic material comprised in the coating, more preferably having a framework type CHA, has a BET specific surface area in the range of from 50 to 900 m²/g, more preferably in the range of from 150 to 700 m²/g, more preferably in the range of from 250 to 650 m²/g, determined as described in Reference Example 1.

Preferably from 50 to 92 weight-%, more preferably from 65 to 90 weight-%, more preferably from 70 to 85 weight-%, of the coating consist of the zeolitic material.

More preferably, when the substrate of the catalyst of the present invention is a flow through substrate, from 80 to 85 weight-% of the coating consist of the zeolitic material. Alternatively, when the substrate of the catalyst of the present invention is a wall flow filter substrate, more preferably from 72 to 78 weight-% of the coating consist of the zeolitic material.

Preferably from 25 to 65 weight-%, more preferably from 30 to 60 weight-%, more preferably from 40 to 55 weight-%, more preferably from 45 to 55 weight-%, of the first non-zeolitic oxidic material consists of iron, calculated as Fe₂O₃.

Preferably from 35 to 75 weight-%, more preferably from 40 to 70 weight-%, more preferably from 45 to 60 weight-%, more preferably from 45 to 55 weight-%, of the first non-zeolitic oxidic material consists of aluminum, calculated as Al₂O₃.

Preferably, in the first non-zeoltic oxidic material, the weight ratio of aluminum to iron, calculated as weight Al₂O₃:Fe₂O₃ ratio, is in the range of from 0.5:1 to 3:1, preferably in the range of from 2.33:1 to 1.5:1, more preferably in the range of from 0.8:1 to 1.2:1, more preferably in the range of from 0.9:1 to 1.1:1.

Preferably, the first non-zeolitic oxidic material is one or more of a mixture of oxides comprising Al and Fe, a mixed oxide comprising Al and Fe and an oxide of Al impregnated with Fe, more preferably one or more of a mixed oxide comprising Al and Fe and an oxide of Al impregnated with Fe.

Preferably the first non-zeolitic oxidic material has a BET specific surface area in the range of from 50 to 300 m²/g, more preferably in the range of from 80 to 160 m²/g.

Preferably the coating comprises the first non-zeolitic oxidic material in an amount in the range of from 5 to 20 weight-%, more preferably in the range of from 7 to 15 weight-%, more preferably in the range of from 8 to 12 weight-%, based on the weight of the zeolitic material.

Preferably, the present invention relates to a catalyst for the selective catalytic reduction of NOx comprising
a substrate having an inlet end, an outlet end, a substrate axial length extending from the inlet end to the outlet end and a plurality of passages defined by internal walls of the substrate extending therethrough;
a coating comprising a zeolitic material, copper and a first non-zeolitic oxidic material comprising iron and aluminum, wherein at least 25 weight-% of the first non-zeolitic oxidic material consists of iron, calculated as Fe₂O₃;
wherein the coating comprises the first non-zeolitic oxidic material in an amount in the range of from 5 to 20 weight-%, more preferably in the range of from 7 to 15 weight-%, more preferably in the range of from 8 to 12 weight-%, based on the weight of the zeolitic material.

Preferably, the present invention relates to a catalyst for the selective catalytic reduction of NOx comprising
a substrate having an inlet end, an outlet end, a substrate axial length extending from the inlet end to the outlet end and a plurality of passages defined by internal walls of the substrate extending therethrough;
a coating comprising a zeolitic material, copper and a first non-zeolitic oxidic material comprising iron and aluminum, wherein at least 25 weight-% of the first non-zeolitic oxidic material consists of iron, calculated as Fe₂O₃;
wherein the coating comprises the first non-zeolitic oxidic material in an amount in the range of from 5 to 20 weight-%, more preferably in the range of from 7 to 15 weight-%, more preferably in the range of from 8 to 12 weight-%, based on the weight of the zeolitic material;
wherein the zeolitic material has a framework type selected from the group consisting of CHA, AEI, RTH, LEV, DDR, KFI, ERI, AFX, a mixture of two or more thereof and a mixed type of two or more thereof, more preferably selected from the group consisting of CHA, AEI, RTH, AFX, a mixture of two or more thereof and a mixed type of two or more thereof, more preferably selected from the group consisting of CHA and AEI, more the zeolitic material comprised in the coating has a framework type CHA.

In the context of the present invention, preferably, in the catalyst, the weight ratio of the zeolitic material relative to the first non-zeolitic oxidic material is in the range of from 5:1 to 20:1, more preferably in the range of from 6.7:1 to 14.3:1, more preferably in the range of from 8.3:1 to 12.5:1.

Preferably, the present invention relates to a catalyst for the selective catalytic reduction of NOx comprising
a substrate having an inlet end, an outlet end, a substrate axial length extending from the inlet end to the outlet end and a plurality of passages defined by internal walls of the substrate extending therethrough;
a coating comprising a zeolitic material, copper and a first non-zeolitic oxidic material comprising iron and aluminum, wherein at least 25 weight-% of the first non-zeolitic oxidic material consists of iron, calculated as Fe₂O₃;
wherein, in the catalyst, the weight ratio of the zeolitic material relative to the first non-zeolitic oxidic material is in the range of from 5:1 to 20:1, more preferably in the range of from 6.7:1 to 14.3:1, more preferably in the range of from 8.3:1 to 12.5:1.

Preferably, the present invention relates to a catalyst for the selective catalytic reduction of NOx comprising
a substrate having an inlet end, an outlet end, a substrate axial length extending from the inlet end to the outlet end and a plurality of passages defined by internal walls of the substrate extending therethrough;
a coating comprising a zeolitic material, copper and a first non-zeolitic oxidic material comprising iron and aluminum, wherein at least 25 weight-% of the first non-zeolitic oxidic material consists of iron, calculated as Fe₂O₃;
wherein, in the catalyst, the weight ratio of the zeolitic material relative to the first non-zeolitic oxidic material is in the range of from 5:1 to 20:1, more preferably in the range of from 6.7:1 to 14.3:1, more preferably in the range of from 8.3:1 to 12.5:1.;
wherein the zeolitic material has a framework type selected from the group consisting of CHA, AEI, RTH, LEV, DDR, KFI, ERI, AFX, a mixture of two or more thereof and a mixed type of two or more thereof, more preferably selected from the group consisting of CHA, AEI, RTH, AFX, a mixture of two or more thereof and a mixed type of two or more thereof, more preferably selected from the group consisting of CHA and AEI, more the zeolitic material comprised in the coating has a framework type CHA.

In the context of the present invention, preferably from 99 to 100 weight-%, more preferably from 99.5 to 100 weight-%, more preferably from 99.9 to 100 weight-%, of the first non-zeolitic oxidic material consist of Al, Fe and O. In other words, the first non-zeolitic oxidic material preferably consists essentially of, more preferably consists of, Al, Fe and O.

Preferably from 0 to 0.01 weight-%, more preferably from 0 to 0.001 weight-%, more preferably from 0 to 0.0001 weight-%, of the first non-zeolitic oxidic material consist of cerium, calculated as CeO₂. In other words, the non-zeolitic oxidic material is preferably substantially free of, more preferably free of, cerium.

Preferably the coating further comprises a second non-zeolitic oxidic material, the second non-zeolitic oxidic material more preferably comprises one or more of zirconia, alumina, titania, silica, and a mixed oxide comprising two or more of Zr, Al, Ti, and Si, more preferably comprises one or more of silica, alumina and zirconia, more preferably comprises one or more of alumina and zirconia, more preferably zirconia.

Preferably from 95 to 100 weight-%, more preferably from 98 to 100 weight-%, more preferably from 99 to 100 weight-%, more preferably from 99.5 to 100 weight-%, of the second non-zeolitic oxidic material comprised in the coating consists of zirconium, calculated as ZrO₂. In other words, the second non-zeolitic oxidic material comprised in the coating preferably essentially consists of, more preferably consists of, zirconia.

Preferably the coating comprises a second non-zeolitic oxidic material in an amount in the range of from 2 to 40 weight-%, more preferably in the range of from 2.5 to 30 weight-%, more preferably in the range of from 3 to 25 weight-%, based on the weight of the zeolitic material. More preferably the coating comprises a second non-zeolitic oxidic material in an amount in the range of from 3 to 10 weight-%, more preferably in the range of from 3.5 to 7 weight-% based on the weight of the zeolitic material; or the coating more preferably comprises a second non-zeolitic oxidic material in an amount in the range of from 15 to 25 weight-%, more preferably in the range of from 17 to 22 weight-% based on the weight of the zeolitic material.

More preferably, when the substrate of the catalyst of the present invention is a flow through substrate, the coating comprises a second non-zeolitic oxidic material in an amount in the range of from 3 to 10 weight-%, more preferably in the range of from 3.5 to 7 weight-% based on the weight of the zeolitic material. Alternatively, when the substrate of the catalyst of the present invention is a wall flow filter substrate, the coating comprises a second non-zeolitic oxidic material in an amount in the range of from 15 to 25 weight-%, more preferably in the range of from 17 to 22 weight-% based on the weight of the zeolitic material.

Preferably from 98 to 100 weight-%, more preferably from 99 to 100 weight-%, more preferably from 99.5 to 100 weight-%, more preferably from 99.9 to 100 weight-%, of the coating consist of copper, the zeolitic material optionally comprising iron, the first non-zeolitic oxidic material comprising Fe and Al, and more preferably a second non-zeolitic oxidic material as defined in the foregoing. In other words, it is preferred that the coating consists essentially of, more preferably consists of, copper, the zeolitic material optionally comprising iron, the first non-zeolitic oxidic material comprising Fe and Al, and more preferably a second non-zeolitic oxidic material as defined in the foregoing.

Preferably, the substrate is made of one or more of cordierite, silicon carbide and aluminum titanate, more preferably one or more of cordierite and silicon carbide, more preferably cordierite or silicon carbide.

Preferably, according to a first aspect of the present invention, the substrate is a wall flow filter substrate, wherein the plurality of passages comprises inlet passages having an open inlet end and a closed outlet end, and outlet passages having a closed inlet end and an open outlet end.

Preferably, the wall flow filter substrate is made of one or more of silicon carbide and aluminum titanate, more preferably silicon carbide.

Preferably, the coating is located within the porous walls of the wall flow filter substrate.

Preferably, according to said first aspect of the present invention, the coating is disposed homogeneously along the substrate axial length. Alternatively, preferably, the amount of coating is higher in the middle zone of the substrate axial length compared to the amount present at each of the inlet end of the substrate and the outlet end of the substrate. More preferably, according to said first aspect of the present invention, the amount of coating is higher in the middle zone of the substrate axial length compared to the amount present at each of the inlet end of the substrate and the outlet end of the substrate. This is illustrated by the examples below.

Preferably, according to said first aspect, the substrate comprises the coating at a loading in the range of from 0.5 to 3 g/in³, more preferably in the range of from 0.75 to 2.5 g/in³, more preferably in the range of from 1 to 2 g/in³.

Preferably, according to a second aspect of the present invention, the substrate is a flow through substrate. More preferably the flow through substrate is made of cordierite.

Preferably, according to said second aspect, the coating is located on the surface of the internal walls of the substrate.

Preferably, according to said second aspect, the coating is disposed homogeneously along the substrate axial length.

Preferably, according to said second aspect, the substrate comprises the coating at a loading in the range of from 0.75 to 5.5 g/in³, more preferably in the range of from 1.25 to 4.5 g/in³, more preferably in the range of from 2 to 4 g/in³.

In the context of the present invention, the coating is preferably disposed over 98 to 100%, more preferably over 99 to 100%, of the substrate axial length.

Preferably, the catalyst of the present invention consists of the substrate and the coating.

Further, the present invention relates to a process for preparing a catalyst for the selective catalytic reduction of NOx, more preferably the catalyst according to the present invention, the process comprising
(i) preparing a first aqueous mixture comprising water, a source of copper, and optionally a precursor of a second non-zeolitic oxidic component;
(ii) admixing the first aqueous mixture obtained according to (i) with water and a zeolitic material, wherein the zeolitic material is free of copper and wherein the zeolitic material optionally comprises iron, obtaining a second aqueous mixture;
(iii) admixing a first non-zeolitic oxidic material comprising Al and Fe to the second aqueous mixture prepared according to (ii), wherein at least 25 weight-% of the first non-zeolitic oxidic material consists of iron, calculated as Fe₂O₃, preferably adding water, obtaining a third aqueous mixture;
(iv) disposing the third aqueous mixture obtained according to (iii) on a substrate comprising an inlet end, an outlet end, a substrate axial length extending from the inlet end to the outlet end and a plurality of passages defined by internal walls of the substrate extending therethrough; and optionally drying the substrate comprising said mixture;
(v) calcining the substrate obtained in (iv).

Preferably, the source of copper comprised in the first aqueous mixture prepared in (i) is selected from the group consisting of copper acetate, copper nitrate, copper sulfate, copper formate, copper oxide, and a mixture of two or more thereof, more preferably selected from the group consisting of copper acetate, copper oxide, and a mixture of thereof, more preferably copper oxide, more preferably CuO.

Preferably, the precursor of a second non-zeolitic oxidic component comprised in the first aqueous mixture prepared in (i) is a zirconium salt or a zirconium oxide, more preferably a zirconium salt, more preferably zirconium acetate.

Preferably the first aqueous mixture prepared in (i) comprises copper, calculated as CuO, at an amount in the range of from 2 to 10 weight-%, more preferably in the range of from 2.5 to 8 weight-%, more preferably in the range of from 3 to 7 weight-%, more preferably in the range of from 3.5 to 6 weight-%, based on the weight of the zeolitic material comprised in the second aqueous mixture prepared in (ii).

Preferably, (i) comprises
(i.1) preparing a mixture comprising water and the source of copper, the mixture more preferably further comprising an acid, more preferably an organic acid, more preferably acetic acid, wherein the mixture optionally more preferably further comprises sucrose;
(i.2) adding the precursor of the second non-zeolitic oxidic component to the mixture obtained according to (i.1), obtaining the first aqueous mixture.

As to (i.1), when the substrate used in (iv) is a wall flow filter substrate, the mixture prepared according to (i.1) preferably comprises sucrose.

More preferably sucrose is present in the mixture prepared in (i.1) in an amount in the range of from 2 to 10 weight-%, more preferably in the range of from 2.5 to 8 weight-%, more preferably in the range of from 3 to 7 weight-%, more preferably in the range of from 3.5 to 6 weight-%, based on the weight of the zeolitic material comprised in the second aqueous mixture prepared in (ii).

More preferably the weight ratio of copper, calculated as CuO, relative to sucrose is in the range of from 2:1 to 1:2, more preferably in the range of from 1.5:1 to 1:1.5, more preferably in the range of from 1.2:1 to 1:1.2.

Preferably from 90 to 100 weight-%, more preferably from 93 to 99 weight-%, more preferably from 96 to 99 weight-%, of the source of copper is present in the mixture prepared in (i.1) in non-dissolved state.

Preferably the particles of copper in the mixture according to (i.1) have a Dv90 in the range of from 0.1 to 15 micrometers, more preferably in the range of from 0.5 to 10 micrometers, more preferably in the range of from 1 to 8 micrometers, more preferably in the range of from 3 to 7 micrometers, the Dv90 being preferably determined as described in Reference Example 3.

Preferably the second mixture obtained in (ii) has a solid content in the range of from 15 to 50 weight-%, more preferably in the range of from 20 to 45 weight-%, more preferably in the range of from 30 to 40 weight-%, based on the weight of the second mixture.

Preferably the particles of the zeolitic material in the second mixture have a Dv50 in the range of from 0.5 to 5 micrometers, preferably in the range of from 0.75 to 3 micrometers, the Dv90 being preferably determined as described in Reference Example 3.

Preferably, (ii) comprises
(ii.1) admixing the first aqueous mixture obtained according to (i) with water and a zeolitic material, wherein the zeolitic material is free of copper and wherein the zeolitic material optionally comprises iron;
(ii.2) milling the obtained mixture (ii.1), more preferably until the particles of said mixture have a Dv90 in the range of from 0.5 to 8 micrometers, more preferably in the range of from 1 to 5 micrometers, more preferably in the range of from 1.5 to 4 micrometers, the Dv90 being preferably determined as described in Reference Example 3, obtaining the third aqueous mixture;
   wherein more preferably the particles of said mixture have a Dv99 in the range of from 1.5 to 12 micrometers, more preferably in the range of from 2 to 10 micrometers, more preferably in the range of from 3 to 7 micrometers, the Dv99 being preferably determined as described in Reference Example 3, obtaining the second aqueous mixture.

Preferably the particles of the first non-zeolitic oxidic material admixed to the second aqueous mixture according to (ii) have a Dv50 in the range of from 3 to 15 micrometers, more preferably in the range of from 6 to 12 micrometers, the Dv50 being preferably determined as described in Reference Example 3.

Preferably the particles of the first non-zeolitic oxidic material admixed to the second aqueous mixture according to (ii) have a Dv90 in the range of from 8 to 40 micrometers, more preferably in the range of from 15 to 25 micrometers, the Dv90 being preferably determined as described in Reference Example 3.

Preferably the particles of the first non-zeolitic oxidic material admixed to the second aqueous mixture according to (ii) have a Dv99 in the range of from 10 to 50 micrometers, more preferably in the range of from 20 to 30 micrometers, the Dv99 being preferably determined as described in Reference Example 3.

Preferably the mixture prepared in (iii) comprises the first non-zeolitic oxidic material in an amount in the range of from 5 to 20 weight-%, more preferably in the range of from 7 to 15 weight-%, more preferably in the range of from 8 to 12 weight-%, based on the weight of the zeolitic material.

Preferably the third aqueous mixture obtained in (iii) has a solid content in the range of from 15 to 50 weight-%, more preferably in the range of from 25 to 48 weight-%, more preferably in the range of from 28 to 40 weight-%, based on the weight of the third aqueous mixture.

Preferably from 98 to 100 weight-%, more preferably from 99 to 100 weight-%, more preferably from 99.5 to 100 weight-%, more preferably from 99.9 to 100 weight-%, of the third aqueous mixture obtained according to (iii) consist of water, the zeolitic material optionally comprising iron, the source of copper, the first non-zeolitic oxidic material comprising Al and Fe, and more preferably the precursor of the second non-zeolitic oxidic material. In other words, the third aqueous mixture obtained according to (iii) preferably essentially consists of, more preferably consists of, water, the zeolitic material optionally comprising iron, the source of copper, the first non-zeolitic oxidic material comprising Al and Fe, and more preferably the precursor of the second non-zeolitic oxidic material.

Preferably disposing the third mixture according to (iv) is performed by spraying the mixture onto the substrate or by immersing the substrate into the mixture, more preferably by immersing the substrate into the mixture.

Preferably the third aqueous mixture obtained according to (iii) is disposed according to (iv) over x % of the substrate axial length from the inlet end to the outlet end of the substrate or from the outlet end to the inlet end of the substrate, wherein x is in the range of from 95 to 100, more preferably in the range of from 98 to 100, more preferably in the range of from 99 to 100.

Preferably the substrate in (iv) is a flow through substrate, the substrate being more preferably made of one or more of cordierite, silicon carbide and aluminum titanate, more preferably one or more of cordierite and silicon carbide, more preferably cordierite.

Preferably (iv) comprises
disposing the third aqueous mixture obtained according to (iii) on a flow through substrate over from 95 to 100%, more preferably from 98 to 100%, more preferably from 99 to 100%, of the substrate axial length from the inlet end towards the outlet end of the substrate or from the outlet end towards the inlet end of the substrate, more preferably from the inlet end towards the outlet end; and drying the substrate comprising said mixture.

Preferably the substrate in (iv) is a wall flow filter substrate, wherein the plurality of passages comprises inlet passages having an open inlet end and a closed outlet end, and outlet passages having a closed inlet end and an open outlet end, the substrate being more preferably made of one or more of cordierite, silicon carbide and aluminum titanate, more preferably one or more of silicon carbide and alumina titanate.

Preferably disposing according to (iv) comprises
(iv.1) disposing a first portion of the third aqueous mixture obtained in (iii) on the wall flow filter substrate over from 40 to 85%, more preferably from 55 to 80%, more preferably from 65 to 75%, of the substrate axial length from the outlet end towards the inlet end of the substrate; and drying the substrate comprising the first portion of the third aqueous mixture;
(iv.2) disposing a second portion of the third aqueous mixture obtained in (iii) on the substrate comprising the first portion of the third aqueous mixture obtained in (iv.1) over from 40 to 85%, more preferably from 55 to 80%, more preferably from 65 to 75%, of the substrate axial length from the inlet end towards the outlet end of the substrate and optionally drying the substrate comprising the first portion and the second portion of the third aqueous mixture.

As an alternative, it is conceivable that the substrate be coated with the first portion over 100% of the substrate axial length from the inlet or outlet end of the substrate and that the substrate be coated with the second portion over 100% of the substrate axial length from the other of the inlet or outlet end of the substrate. It is also conceivable that in (iv.1) disposing is rather performed for the inlet end towards the outlet end and that in (iv.2) disposing is rather performed from the outlet end towards the inlet end.

In the context of the present invention, drying according to (iv) is preferably performed in a gas atmosphere having a temperature in the range of from 60 to 300° C., more preferably in the range of from 90 to 150° C., the gas atmosphere more preferably comprising oxygen.

When (iv) comprises (iv.1) and (iv.2), it is preferred that drying according to (iv.1) and/or (iv.2), more preferably according to (iv.1) and (iv.2), is performed in a gas atmosphere having a temperature in the range of from 60 to 300° C., more preferably in the range of from 90 to 150° C. Preferably drying according to (iv) is performed in a gas atmosphere for a duration in the range of from 10 minutes to 4 hours, more preferably in the range of from 20 minutes to 2 hours.

When (iv) comprises (iv.1) and (iv.2), it is preferred that drying according to (iv.1) and/or (iv.2), more preferably according to (iv.1) and (iv.2), is performed in a gas atmosphere for a duration in the range of from 10 minutes to 4 hours, more preferably in the range of from 20 minutes to 2 hours.

Preferably calcining according to (v) is performed in a gas atmosphere having a temperature in the range of from 300 to 900° C., more preferably in the range of from 400 to 650° C., more preferably in the range of from 400 to 500° C., the gas atmosphere more preferably comprising oxygen.

Preferably calcining according to (v) is performed in a gas atmosphere for a duration in the range of from 0.1 to 4 hours, more preferably in the range of from 0.5 to 2.5 hours.

Preferably, the process of the present invention consists of (i), (ii), (iii), (iv) and (v).

The present invention further relates to a catalyst for the selective catalytic reduction of NOx obtainable or obtained by a process according to the present invention. Said catalyst is preferably as defined in the foregoing.

The present invention further relates to an exhaust gas treatment system for treating exhaust gas exiting a compression ignition engine, more preferably a diesel engine, said exhaust gas treatment system having an upstream end for introducing said exhaust gas stream into said exhaust gas treatment system,
wherein said exhaust gas treatment system comprises
a catalyst according to the present invention and
one or more of a diesel oxidation catalyst, a selective catalytic reduction catalyst, an ammonia oxidation catalyst, a NOx trap and a particulate filter. Preferably, the system comprises a diesel oxidation catalyst, wherein the catalyst according to the present invention is located downstream of the diesel oxidation catalyst.

Preferably the system comprises a diesel oxidation catalyst, a selective catalytic reduction catalyst on filter and the catalyst according to the present invention, wherein the diesel oxidation catalyst is upstream of the selective catalytic reduction catalyst on filter (SCROF) and the catalyst according to the present invention is downstream of the SCROF catalyst;
wherein the system further comprises, downstream of the catalyst according to the present invention, a selective catalytic reduction catalyst or an ammonia oxidation catalyst.

Alternatively, preferably the system comprises a diesel oxidation catalyst, a selective catalytic reduction catalyst and the catalyst according to the present invention, wherein the diesel oxidation catalyst is upstream of the selective catalytic reduction (SCR) catalyst and the catalyst ac-cording to the present invention is downstream of the SCR catalyst;
wherein the system further comprises, downstream of the catalyst according to the present invention, a selective catalytic reduction catalyst or an ammonia oxidation catalyst.

Alternatively, preferably, the system comprises a diesel oxidation catalyst, a selective catalytic reduction catalyst, the catalyst according to the present invention, wherein the diesel oxidation catalyst is upstream of the catalyst according to the present invention and the selective catalytic reduction (SCR) catalyst is downstream of the catalyst according to the present invention;
wherein the system further comprises, downstream of the SCR catalyst, a further selective catalytic reduction catalyst or an ammonia oxidation catalyst.

Alternatively, preferably, the system of the present invention comprises a diesel oxidation catalyst, a selective catalytic reduction catalyst on filter (SCROF), the catalyst according to the present invention, wherein the diesel oxidation catalyst is upstream of the catalyst according to the present invention and the SCROF catalyst is downstream of the catalyst according to the present invention;
wherein the system further comprises, downstream of the SCROF catalyst, a selective catalytic reduction catalyst or an ammonia oxidation catalyst.

The present invention further relates to a use of a catalyst according to the present invention for the selective catalytic reduction of NOx.

The present invention further relates to a method for the selective catalytic reduction of NOx, the method comprising
(1) providing an exhaust gas stream, preferably exiting a diesel engine;
(2) contacting the exhaust gas stream provided in (1) with a catalyst for the selective catalytic reduction of NOx according to the present invention.

The present invention is further illustrated by the following set of embodiments and combinations of embodiments resulting from the dependencies and back-references as indicated. In particular, it is noted that in each instance where a range of embodiments is mentioned, for example in the context of a term such as “The catalyst of any one of embodiments 1 to 4”, every embodiment in this range is meant to be explicitly disclosed for the skilled person, i.e. the wording of this term is to be understood by the skilled person as being synonymous to “The catalyst of any one of embodiments 1, 2, 3, and 4”. Further, it is explicitly noted that the following set of embodiments represents a suitably structured part of the general description directed to preferred aspects of the present invention, and, thus, suitably supports, but does not represent the claims of the present invention.
1. A catalyst for the selective catalytic reduction of NOx comprising
   a substrate having an inlet end, an outlet end, a substrate axial length extending from the inlet end to the outlet end and a plurality of passages defined by internal walls of the substrate extending therethrough;
   a coating comprising a zeolitic material, copper and a first non-zeolitic oxidic material comprising iron and aluminum, wherein at least 25 weight-% of the first non-zeolitic oxidic material consists of iron, calculated as Fe₂O₃.
2. The catalyst of embodiment 1, wherein the zeolitic material comprised in the coating has a framework type selected from the group consisting of ABW, ACO, AEI, AEL, AEN, AET, AFG, AFI, AFN, AFO, AFR, AFS, AFT, AFV, AFX, AFY, AHT, ANA, APC, APD, AST, ASV, ATN, ATO, ATS, ATT, ATV, AVL, AWO, AWW, BCT, BEA, BEC, BIK, BOF, BOG, BOZ, BPH, BRE, BSV, CAN, CAS, CDO, CFI, CGF, CGS, CHA,-CHI,-CLO, CON, CSV, CZP, DAC, DDR, DFO, DFT, DOH, DON, EAB, EDI, EEI, EMT, EON, EPI, ERI, ESV, ETR, EUO, *-EWT, EZT, FAR, FAU, FER, FRA, GIS, GIU, GME, GON, GOO, HEU, IFO, IFR,-IFU, IFW, IFY, IHW, IMF, IRN, IRR,-IRY, ISV, ITE, ITG, ITH, *-ITN, ITR, ITT,-ITV, ITW, IWR, IWS, IWV, IWW, JBW, JNT, JOZ, JRY, JSN, JSR, JST, JSW, KFI, LAU, LEV, LIO,-LIT, LOS, LOV, LTA, LTF, LTJ, LTL, LTN, MAR, MAZ, MEI, MEL, MEP, MER, MFI, MFS, MON, MOR, MOZ, *MRE, MSE, MSO, MTF, MTN, MTT, MTW, MVY, MWF, MWW, NAB, NAT, NES, NON, NPO, NPT, NSI, OBW, OFF, OKO, OSI, OSO, OWE,-PAR, PAU, PCR, PHI, PON, POS, PSI, PUN, RHO,-RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, *SFV, SFW, SGT, SIV, SOD, SOF, SOS, SSF, *-SSO, SSY, STF, STI, *STO, STT, STW,-SVR, SVV, SZR, TER, THO, TOL, TON, TSC, TUN, UEI, UFI, UOS, UOV, UOZ, USI, UTL, UWY, VET, VFI, VNI, VSV, WEI,-WEN, YUG, ZON, a mixture of two or more thereof, and a mixed type of two or more thereof, preferably selected from the group consisting of CHA, AEI, RTH, LEV, DDR, KFI, ERI, AFX, a mixture of two or more thereof and a mixed type of two or more thereof, more preferably selected from the group consisting of CHA, AEI, RTH, AFX, a mixture of two or more thereof and a mixed type of two or more thereof, more preferably selected from the group consisting of CHA and AEI, where-in the zeolitic material comprised in the coating more preferably has a framework type CHA.
3. The catalyst of embodiment 1 or 2, wherein from 95 to 100 weight-%, preferably from 98 to 100 weight-%, more preferably from 99 to 100 weight-% of the framework structure of the zeolitic material consist of Si, Al, and O, wherein in the framework structure, the molar ratio of Si to Al, calculated as molar SiO₂:Al₂O₃, is preferably in the range of from 2:1 to 30:1, more preferably in the range of from 5:1 to 28:1, more preferably in the range of from 8:1 to 26:1,
   more preferably in the range of from 10:1 to 19:1, more preferably in the range of from 12:1 to 18:1; or
   more preferably in the range of from 20:1 to 25:1.
4. The catalyst of any one of embodiments 1 to 3, wherein the zeolitic material comprised in the coating, preferably which has a framework type CHA, has a mean crystallite size of at least 0.1 micrometer, preferably in the range of from 0.1 to 3.0 micrometers, more preferably in the range of from 0.3 to 1.5 micrometer, more preferably in the range of from 0.4 to 1.0 micrometer determined via scanning electron microscopy.
5. The catalyst of any one of embodiments 1 to 4, wherein the amount of copper comprised in the coating, calculated as CuO, is in the range of from 2 to 10 weight-%, preferably in the range of from 2.5 to 8 weight-%, more preferably in the range of from 3 to 7 weight-%, more preferably in the range of from 3.5 to 6 weight-%, based on the weight of the zeolitic material; wherein the zeolitic material comprised in the coating preferably comprises the copper.
6. The catalyst of any one of embodiments 1 to 5, wherein the zeolitic material comprises iron, wherein the amount of iron comprised in the zeolitic material, calculated as Fe₂O₃, is in the range of from 0.1 to 1.5 weight-%, preferably in the range of from 0.15 to 1.25 weight-%, more preferably in the range of from 0.25 to 1 weight-%, more preferably in the range of from 0.3 to 0.8 weight-%, based on the weight of the zeolitic material.
7. The catalyst of any one of embodiments 1 to 6, wherein the coating comprises the zeolitic material at a loading in the range of from 0.25 to 5 g/in³, preferably in the range of from 0.75 to 3 g/in³, more preferably in the range of from 1 to 2.5 g/in³, more preferably in the range of from 1.25 to 2.2 g/in³.
8. The catalyst of any one of embodiments 1 to 7, wherein the zeolitic material comprised in the coating, preferably having a framework type CHA, has a BET specific surface area in the range of from 50 to 900 m²/g, preferably in the range of from 150 to 700 m²/g, more preferably in the range of from 250 to 650 m²/g, determined as described in Reference Example 1.
9. The catalyst of any one of embodiments 1 to 8, wherein from 50 to 92 weight-%, preferably from 65 to 90 weight-%, more preferably from 70 to 85 weight-%, of the coating consist of the zeolitic material.
10. The catalyst of any one of embodiments 1 to 9, wherein from 25 to 65 weight-%, preferably from 30 to 60 weight-%, more preferably from 40 to 55 weight-%, more preferably from 45 to 55 weight-%, of the first non-zeolitic oxidic material consists of iron, calculated as Fe₂O₃.
11. The catalyst of any one of embodiments 1 to 10, wherein from 35 to 75 weight-%, preferably from 40 to 70 weight-%, more preferably from 45 to 60 weight-%, more preferably from 45 to 55 weight-%, of the first non-zeolitic oxidic material consists of aluminum, calculated as Al₂O₃.
12. The catalyst of any one of embodiments 1 to 11, wherein the first non-zeolitic oxidic material is one or more of a mixture of oxides comprising Al and Fe, a mixed oxide comprising Al and Fe and an oxide of Al impregnated with Fe, preferably one or more of a mixed oxide comprising Al and Fe and an oxide of Al impregnated with Fe;
   wherein the first non-zeolitic oxidic material has a BET specific surface area in the range of from 50 to 300 m²/g, more preferably in the range of from 80 to 160 m²/g.
13. The catalyst of any one of embodiments 1 to 12, wherein the coating comprises the first non-zeolitic oxidic material in an amount in the range of from 5 to 20 weight-%, preferably in the range of from 7 to 15 weight-%, more preferably in the range of from 8 to 12 weight-%, based on the weight of the zeolitic material.
14. The catalyst of any one of embodiments 1 to 13, wherein from 99 to 100 weight-%, preferably from 99.5 to 100 weight-%, more preferably from 99.9 to 100 weight-%, of the first non-zeolitic oxidic material consist of Al, Fe and O.
15. The catalyst of any one of embodiments 1 to 14, wherein from 0 to 0.01 weight-%, preferably from 0 to 0.001 weight-%, more preferably from 0 to 0.0001 weight-%, of the first non-zeolitic oxidic material consist of cerium, calculated as CeO₂.
16. The catalyst of any one of embodiments 1 to 15, wherein the coating further comprises a second non-zeolitic oxidic material, the second non-zeolitic oxidic material preferably comprises one or more of zirconia, alumina, titania, silica, and a mixed oxide comprising two or more of Zr, Al, Ti, and Si, more preferably comprises one or more of silica, alumina and zirconia, more preferably comprises one or more of alumina and zirconia, more preferably zirconia;
   wherein preferably from 95 to 100 weight-%, more preferably from 98 to 100 weight-%, more preferably from 99 to 100 weight-%, more preferably from 99.5 to 100 weight-%, of the second non-zeolitic oxidic material comprised in the coating consists of zirconium, calculated as ZrO₂.
17. The catalyst of any one embodiments 1 to 16, wherein the coating comprises a second non-zeolitic oxidic material in an amount in the range of from 2 to 40 weight-%, preferably in the range of from 2.5 to 30 weight-%, more preferably in the range of from 3 to 25 weight-%, based on the weight of the zeolitic material.
18. The catalyst of any one embodiments 1 to 16, wherein from 98 to 100 weight-%, preferably from 99 to 100 weight-%, more preferably from 99.5 to 100 weight-%, more preferably from 99.9 to 100 weight-%, of the coating consist of copper, the zeolitic material optionally comprising iron, the first non-zeolitic oxidic material comprising Fe and Al, and preferably a second non-zeolitic oxidic material as defined in embodiment 16 or 17.
19. The catalyst of any one of embodiments 1 to 18, wherein the substrate is made of one or more of cordierite, silicon carbide and aluminum titanate, preferably one or more of cordierite and silicon carbide, more preferably cordierite or silicon carbide.
20. The catalyst of any one of embodiments 1 to 19, wherein the substrate is a wall flow filter substrate, wherein the plurality of passages comprises inlet passages having an open inlet end and a closed outlet end, and outlet passages having a closed inlet end and an open outlet end; wherein the wall flow filter substrate is preferably made of one or more of silicon carbide, aluminum titanate, more preferably silicon carbide.
21. The catalyst of embodiment 20, wherein the coating is located within the porous walls of the wall flow filter substrate.
22. The catalyst of embodiment 20 or 21, wherein the coating is disposed homogeneously along the substrate axial length or wherein the amount of coating is higher in the middle zone of the substrate axial length compared to the amount present at each of the inlet end of the substrate and the outlet end of the substrate, preferably wherein the amount of coating is higher in the middle zone of the substrate axial length compared to the amount present at each of the inlet end of the substrate and the outlet end of the substrate.
23. The catalyst of any one of embodiments 20 to 22, wherein the substrate comprises the coating at a loading in the range of from 0.5 to 3 g/in³, preferably in the range of from 0.75 to 2.5 g/in³, preferably in the range of from 1 to 2 g/in³.
24. The catalyst of any one of embodiments 1 to 19, wherein the substrate is a flow through substrate; wherein the flow through substrate is preferably made of cordierite.
25. The catalyst of embodiment 24, wherein the coating is located on the surface of the internal walls of the substrate.
26. The catalyst of embodiment 24 or 25, wherein the coating is disposed homogeneously along the substrate axial length.
27. The catalyst of any one of embodiments 24 to 26, wherein the substrate comprises the coating at a loading in the range of from 0.75 to 5.5 g/in³, preferably in the range of from 1.25 to 4.5 g/in³, more preferably in the range of from 2 to 4 g/in³.
28. The catalyst of any one of embodiments 1 to 27, wherein the coating is disposed over 98 to 100%, preferably over 99 to 100%, of the substrate axial length.
29. The catalyst of any one of embodiments 1 to 28, consists of the substrate and the coating.
30. A process for preparing a catalyst for the selective catalytic reduction of NOx, preferably the catalyst according to any one of embodiments 1 to 29, the process comprising
   (i) preparing a first aqueous mixture comprising water, a source of copper, and optionally a precursor of a second non-zeolitic oxidic component;
   (ii) admixing the first aqueous mixture obtained according to (i) with water and a zeolitic material, wherein the zeolitic material is free of copper and wherein the zeolitic material optionally comprises iron, obtaining a second aqueous mixture;
   (iii) admixing a first non-zeolitic oxidic material comprising Al and Fe to the second aqueous mixture prepared according to (ii), wherein at least 25 weight-% of the first non-zeolitic oxidic material consists of iron, calculated as Fe₂O₃, preferably adding water, obtaining a third aqueous mixture;
   (iv) disposing the third aqueous mixture obtained according to (iii) on a substrate comprising an inlet end, an outlet end, a substrate axial length extending from the inlet end to the outlet end and a plurality of passages defined by internal walls of the substrate extending therethrough; and optionally drying the substrate comprising said mixture;
   (v) calcining the substrate obtained in (iv).
31. The process of embodiment 30, wherein the source of copper comprised in the first aqueous mixture prepared in (i) is selected from the group consisting of copper acetate, copper nitrate, copper sulfate, copper formate, copper oxide, and a mixture of two or more thereof, preferably selected from the group consisting of copper acetate, copper oxide, and a mixture of thereof, more preferably copper oxide, more preferably CuO.
32. The process of embodiment 30 or 31, wherein the precursor of a second non-zeolitic oxidic component comprised in the first aqueous mixture prepared in (i) is a zirconium salt or a zirconium oxide, preferably a zirconium salt, more preferably zirconium acetate.
33. The process of any one of embodiments 30 to 32, wherein the first aqueous mixture prepared in (i) comprises copper, calculated as CuO, at an amount in the range of from 2 to 10 weight-%, preferably in the range of from 2.5 to 8 weight-%, more preferably in the range of from 3 to 7 weight-%, more preferably in the range of from 3.5 to 6 weight-%, based on the weight of the zeolitic material comprised in the second aqueous mixture prepared in (ii).
34. The process of any one of embodiments 30 to 33, wherein (i) comprises
   (i.1) preparing a mixture comprising water and the source of copper, the mixture preferably further comprising an acid, more preferably an organic acid, more preferably acetic acid, wherein the mixture optionally preferably further comprises sucrose;
   (i.2) adding the precursor of the second non-zeolitic oxidic component to the mixture obtained according to (i.1), obtaining the first aqueous mixture.
35. The process of embodiment 34, wherein from 90 to 100 weight-%, preferably from 93 to 99 weight-%, more preferably from 96 to 99 weight-%, of the source of copper is present in the mixture prepared in (i.1) in non-dissolved state.
36. The process of embodiment 35, wherein the particles of copper in the mixture according to (i.1) have a Dv90 in the range of from 0.1 to 15 micrometers, preferably in the range of from 0.5 to 10 micrometers, more preferably in the range of from 1 to 8 micrometers, more preferably in the range of from 3 to 7 micrometers, the Dv90 being preferably determined as described in Reference Example 3.
37. The process of any one of embodiments 30 to 36, wherein the second mixture obtained in (ii) has a solid content in the range of from 15 to 50 weight-%, preferably in the range of from 20 to 45 weight-%, more preferably in the range of from 30 to 40 weight-%, based on the weight of the second mixture.
38. The process of any one of embodiments 30 to 37, wherein the particles of the zeolitic material in the second mixture have a Dv50 in the range of from 0.5 to 5 micrometers, preferably in the range of from 0.75 to 3 micrometers, the Dv90 being preferably determined as described in Reference Example 3.
39. The process of any one of embodiments 30 to 38, wherein (ii) comprises
   (ii.1) admixing the first aqueous mixture obtained according to (i) with water and a zeolitic material, wherein the zeolitic material is free of copper and wherein the zeolitic material optionally comprises iron;
   (ii.2) milling the obtained mixture (ii.1), preferably until the particles of said mixture have a Dv90 in the range of from 0.5 to 8 micrometers, more preferably in the range of from 1 to 5 micrometers, more preferably in the range of from 1.5 to 4 micrometers, the Dv90 being preferably determined as described in Reference Example 3, obtaining the third aqueous mixture;
      wherein more preferably the particles of said mixture have a Dv99 in the range of from 1.5 to 12 micrometers, more preferably in the range of from 2 to 10 micrometers, more preferably in the range of from 3 to 7 micrometers, the Dv99 being preferably determined as described in Reference Example 3, obtaining the second aqueous mixture.
40. The process of any one of embodiments 30 to 39, wherein the particles of the first non-zeolitic oxidic material admixed to the second aqueous mixture according to (ii) have a Dv90 in the range of from 8 to 40 micrometers, preferably in the range of from 15 to 25 micrometers, the Dv90 being preferably determined as described in Reference Example 3.
41. The process of any one of embodiments 30 to 40, wherein the particles of the first non-zeolitic oxidic material admixed to the second aqueous mixture according to (ii) have a Dv99 in the range of from 10 to 50 micrometers, preferably in the range of from 20 to 30 micrometers, the Dv99 being preferably determined as described in Reference Example 3.
42. The process of any one of embodiments 30 to 41, wherein the particles of the first non-zeolitic oxidic material admixed to the second aqueous mixture according to (ii) have a Dv50 in the range of from 3 to 15 micrometers, preferably in the range of from 6 to 12 micrometers, the Dv50 being preferably determined as described in Reference Example 3.
43. The process of any one of embodiments 30 to 42, wherein the mixture prepared in (iii) comprises the first non-zeolitic oxidic material in an amount in the range of from 5 to 20 weight-%, preferably in the range of from 7 to 15 weight-%, more preferably in the range of from 8 to 12 weight-%, based on the weight of the zeolitic material.
44. The process of any one of embodiments 30 to 43, wherein the third aqueous mixture obtained in (iii) has a solid content in the range of from 15 to 50 weight-%, preferably in the range of from 25 to 48 weight-%, more preferably in the range of from 28 to 40 weight-%, based on the weight of the third aqueous mixture.
45. The process of any one of embodiments 30 to 44, wherein from 98 to 100 weight-%, preferably from 99 to 100 weight-%, more preferably from 99.5 to 100 weight-%, more preferably from 99.9 to 100 weight-%, of the third aqueous mixture obtained according to (iii) consist of water, the zeolitic material optionally comprising iron, the source of copper, the first non-zeolitic oxidic material comprising Al and Fe, and preferably the precursor of the second non-zeolitic oxidic material.
46. The process of any one of embodiments 30 to 45, wherein disposing the third mixture according to (iv) is performed by spraying the mixture onto the substrate or by immersing the substrate into the mixture, preferably by immersing the substrate into the mixture.
47. The process of any one of embodiments 30 to 46, wherein the third aqueous mixture obtained according to (iii) is disposed according to (iv) over x % of the substrate axial length from the inlet end to the outlet end of the substrate or from the outlet end to the inlet end of the substrate, wherein x is in the range of from 95 to 100, preferably in the range of from 98 to 100, more preferably in the range of from 99 to 100.
48. The process of any one of embodiments 30 to 47, wherein the substrate in (iv) is a flow through substrate, the substrate being preferably made of one or more of cordierite, silicon carbide and aluminum titanate, preferably one or more of cordierite and silicon carbide, more preferably cordierite.
49. The process of embodiment 48, wherein (iv) comprises disposing the third aqueous mixture obtained according to (iii) on a flow through substrate over from 95 to 100%, preferably from 98 to 100%, more preferably from 99 to 100%, of the substrate axial length from the inlet end towards the outlet end of the substrate or from the outlet end towards the inlet end of the substrate, preferably from the inlet end towards the outlet end; and drying the substrate comprising said mixture.
50. The process of any one of embodiments 30 to 47, wherein the substrate in (iv) is a wall flow filter substrate, wherein the plurality of passages comprises inlet passages having an open inlet end and a closed outlet end, and outlet passages having a closed inlet end and an open outlet end, the substrate being preferably made of one or more of cordierite, silicon carbide and aluminum titanate, more preferably one or more of silicon carbide and alumina titanate.
51. The process of embodiment 50, wherein disposing according to (iv) comprises
   (iv.1) disposing a first portion of the third aqueous mixture obtained in (iii) on the wall flow filter substrate over from 40 to 85%, preferably from 55 to 80%, more preferably from 65 to 75%, of the substrate axial length from the outlet end towards the inlet end of the substrate; and drying the substrate comprising the first portion of the third aqueous mixture;
   (iv.2) disposing a second portion of the third aqueous mixture obtained in (iii) on the substrate comprising the first portion of the third aqueous mixture obtained in (iv.1) over from 40 to 85%, preferably from 55 to 80%, more preferably from 65 to 75%, of the substrate axial length from the inlet end towards the outlet end of the substrate and optionally drying the substrate comprising the first portion and the second portion of the third aqueous mixture.
52. The process of any one of embodiments 30 to 51, wherein drying according to (iv) is performed in a gas atmosphere having a temperature in the range of from 60 to 300° C., preferably in the range of from 90 to 150° C., the gas atmosphere preferably comprising oxygen;
   wherein drying according to (iv) is preferably performed in a gas atmosphere for a duration in the range of from 10 minutes to 4 hours, more preferably in the range of from 20 minutes to 2 hours.
53. The process of any one of embodiments 30 to 52, wherein calcining according to (v) is performed in a gas atmosphere having a temperature in the range of from 300 to 900° C., preferably in the range of from 400 to 650° C., more preferably in the range of from 400 to 500° C., the gas atmosphere preferably comprising oxygen;
   wherein calcining according to (v) is preferably performed in a gas atmosphere for a duration in the range of from 0.1 to 4 hours, more preferably in the range of from 0.5 to 2.5 hours.
54. The process of any one of embodiments 19 to 53 consisting of (i), (ii), (iii), (iv) and (v).
55. A catalyst for the selective catalytic reduction of NOx obtainable or obtained by a process according to any one of embodiments 30 to 54.
56. An exhaust gas treatment system for treating exhaust gas exiting a compression ignition engine, preferably a diesel engine, said exhaust gas treatment system having an upstream end for introducing said exhaust gas stream into said exhaust gas treatment system, wherein said exhaust gas treatment system comprises a catalyst according to any one of embodiments 1 to 29 and 55, one or more of a diesel oxidation catalyst, a selective catalytic reduction catalyst, an ammonia oxidation catalyst, a NOx trap and a particulate filter.
57. The system of embodiment 56, comprising a diesel oxidation catalyst, wherein the catalyst according to any one of embodiments 1 to 29 and 55 is located downstream of the diesel oxidation catalyst.
58. The system of embodiment 56 or 57, comprising a diesel oxidation catalyst, a selective catalytic reduction catalyst on filter, the catalyst according to any one of embodiments 1 to 29 and 55, wherein the diesel oxidation catalyst is upstream of the selective catalytic reduction catalyst on filter (SCROF) and the catalyst according to any one of embodiments 1 to 29 and 55 is downstream of the SCROF catalyst;
   wherein the system further comprises, downstream of the catalyst according to any one of embodiments 1 to 29 and 55, a selective catalytic reduction catalyst or an ammonia oxidation catalyst.
59. The system of embodiment 56 or 57, comprises a diesel oxidation catalyst, a selective catalytic reduction catalyst, the catalyst according to any one of embodiments 1 to 29 and 55, wherein the diesel oxidation catalyst is upstream of the selective catalytic reduction (SCR) catalyst and the catalyst according to any one of embodiments 1 to 29 and 55 is downstream of the SCR catalyst;
   wherein the system further comprises, downstream of the catalyst according to any one of embodiments 1 to 29 and 55, a selective catalytic reduction catalyst or an ammonia oxidation catalyst.
60. The system of embodiment 56 or 57, comprises a diesel oxidation catalyst, a selective catalytic reduction catalyst, the catalyst according to any one of embodiments 1 to 29 and 55, wherein the diesel oxidation catalyst is upstream of the catalyst according to any one of embodiments 1 to 29 and 55 and the selective catalytic reduction (SCR) catalyst is downstream of the catalyst according to any one of embodiments 1 to 29 and 55;
   wherein the system further comprises, downstream of the SCR catalyst, a further selective catalytic reduction catalyst or an ammonia oxidation catalyst.
61. The system of embodiment 56 or 57, comprises a diesel oxidation catalyst, a selective catalytic reduction catalyst on filter (SCROF), the catalyst according to any one of embodiments 1 to 29 and 55, wherein the diesel oxidation catalyst is upstream of the catalyst ac-cording to any one of embodiments 1 to 29 and 55 and the SCROF catalyst is downstream of the catalyst according to any one of embodiments 1 to 29 and 55;
   wherein the system further comprises, downstream of the SCROF catalyst, a selective catalytic reduction catalyst or an ammonia oxidation catalyst.
62. Use of a catalyst according to any one of embodiments 1 to 29 and 55 for the selective catalytic reduction of NOx.
63. A method for the selective catalytic reduction of NOx, the method comprising
   (1) providing an exhaust gas stream, preferably exiting a diesel engine;
   (2) contacting the exhaust gas stream provided in (1) with a catalyst for the selective catalytic reduction of NOx according to any one of embodiments 1 to 29 and 55.

Further, it is explicitly noted that the above set of embodiments represents a suitably structured part of the general description directed to preferred aspects of the present invention, and, thus, suitably supports, but does not represent the claims of the present invention.

Systems according to the present invention are listed in the Table below.

| Systems | Catalyst 1 | Catalyst 2 | Catalyst 3 | Catalyst 4 |
|---|---|---|---|---|
| 1 | DOC | SCRoF | Cat. as SCR | SCR or AMOx |
| 2 | DOC | SCR | Cat. as SCRoF | SCR or AMOx |
| 3 | DOC | Cat. as SCRoF | SCR | SCR or AMOx |
| 4 | DOC | Cat. as SCR | SCRoF | SCR or AMOx |

Catalyst 1 is located upstream of Catalyst 2 and Catalyst 2 is located upstream of Catalyst 3 and Catalyst 3 is located upstream of Catalyst 4. In the above table, “Cat.” designates the catalyst according to the present invention. Further, “DOC” designates a diesel oxidation catalyst, “SCR” a selective catalytic reduction catalyst and “AMOx” an ammonia oxidation catalyst. “Cat. as SCR” means that the catalyst according to the present invention is a SCR catalyst on a flow-through substrate and “Cat. as SCROF” means that the catalyst according to the present invention is a SCR catalyst on a wall-flow filter substrate.

In the context of the present invention, the term “SCR” designates a selective catalytic reduction catalyst and the term “SCROF” designates a selective catalytic reduction catalyst on a wall-flow filter substrate.

In the context of the present invention, it is preferred that the catalyst of the present invention is located downstream of a diesel engine.

Further, in the context of the present invention, the term “loading of a given component/coating” (in g/in³ or g/ft³) refers to the mass of said component/coating per volume of the substrate, wherein the volume of the substrate is the volume which is defined by the cross-section of the substrate times the axial length of the substrate over which said component/coating is present. For example, if reference is made to the loading of a first coating extending over x % of the axial length of the substrate and having a loading of X g/in³, said loading would refer to X gram of the first coating per x % of the volume (in in³) of the entire substrate.

Further, in the context of the present invention, the term “based on the weight of the zeolitic material” refers to the weight of the zeolitic material alone, meaning without copper.

Furthermore, in the context of the present invention, a term “X is one or more of A, B and C”, wherein X is a given feature and each of A, B and C stands for specific realization of said feature, is to be understood as disclosing that X is either A, or B, or C, or A and B, or A and C, or B and C, or A and B and C. In this regard, it is noted that the skilled person is capable of transfer to above abstract term to a concrete example, e.g. where X is a chemical element and A, B and C are concrete elements such as Li, Na, and K, or X is a temperature and A, B and C are concrete temperatures such as 10° C., 20° C., and 30° C. In this regard, it is further noted that the skilled person is capable of extending the above term to less specific realizations of said feature, e.g. “X is one or more of A and B” disclosing that X is either A, or B, or A and B, or to more specific realizations of said feature, e.g. “X is one or more of A, B, C and D”, disclosing that X is either A, or B, or C, or D, or A and B, or A and C, or A and D, or B and C, or B and D, or C and D, or A and B and C, or A and B and D, or B and C and D, or A and B and C and D.

The present invention is further illustrated by the following Examples.

### EXAMPLES

### Reference Example 1 Measurement of the BET Specific Surface Area and Micropore Surface Area (ZSA)

The BET specific surface area and ZSA was determined according to DIN 66131 or DIN-ISO 9277 using liquid nitrogen.

### Reference Example 2 Measurement of the Average Porosity and the Average Pore Size of the Porous Wall-Flow Substrate

The average porosity of the porous wall-flow substrate was determined by mercury intrusion using mercury porosimetry according to DIN 66133 and ISO 15901-1.

### Reference Example 3 Determination of the Volume-Based Particle Size Distributions

The particle size distributions were determined by a static light scattering method using Sympatec HELOS (3200) & QUIXEL equipment, wherein the optical concentration of the sample was in the range of from 6 to 10%.

### Reference Example 4 Preparation of Fe-CHA

A H-Chabazite (having a Dv50 of 1.548 micrometers, a SiO₂:Al₂O₃ molar ratio of 15.7:1, a BET specific surface area of 590 m²/g and a micropore surface area (ZSA) of 570 m²/g) was impregnated via incipient wetness impregnation with iron (iron source: Fe-(III)-Nitrate-9 hydrate) such that the amount of iron was 0.6 wt.-% Fe, calculated as Fe₂O₃, based on the weight of the Chabazite.

### Comparative Example 1 SCR Catalyst not According to the Present Invention

A CuO powder having a Dv50 of 1.1 micrometers and a Dv90 of 5.8 micrometers was added to water. The amount of CuO was calculated such that the total amount of copper, calculated as CuO, in the coating after calcination was 5 weight-% based on the weight of the Chabazite. Acetic acid and an aqueous zirconium acetate solution was added to the CuO-containing mixture forming a slurry. The amount of acetic acid was calculated to be 1.7 weight-% of the Chabazite and the amount of zirconium acetate was calculated such that the amount of zirconia in the coating, calculated as ZrO₂, was 5 weight-% based on the weight of the Chabazite. A H-Chabazite (Dv50 of 1.548 micrometers, a SiO₂:Al₂O₃ of 15.7:1, a BET specific area of 590 m²/g and a micropore surface area ZSA of 570 m²/g) was added to the copper containing slurry to form a mixture having a solid content of 41 weight-% based on the weight of said mixture. The resulting slurry was milled using a continuous milling apparatus so that the Dv50 value of the particles was of about 1.35 micrometers, the Dv90 value of the particles was of about 2.5 micrometers and the Dv90 value of the particles was of about 7 micrometers.

An alumina powder (Al₂O₃ 80 weight-% and SiO₂ 20 weight-%, having a BET specific surface area of 185 m²/g, a Dv50 of 6.3 micrometers, and a Dv90 of 16.3 micrometers) was added to the Cu/CHA containing slurry. The amount of alumina+silica was calculated such that the amount of alumina+silica after calcination was 5 weight-% based on the weight of the Chabazite after calcination in the final catalyst. Water was added to the obtained mixture to obtain a mixture with a solid content of 42 wt.-% based on the weight of said mixture.

A porous uncoated flow through substrate, cordierite, (Volume: 2 L, 400 cpsi, 3.5 mil wall thickness, diameter: 5.66 inches x length: 5 inches) was coated in a single coat from the inlet end to the outlet end with the final slurry over 100% of the substrate axial length. To do so, the substrate was dipped in the final slurry from the inlet end until the slurry arrived at the top of the substrate. Further, the coated substrate was dried at 140° C. for 30 minutes and calcined at 450° C. for 1 hour. The final coating loading in the catalyst after calcinations was 2.75 g/in³, including about 2.39 g/in³ of Chabazite, 0.12 g/in³ of zirconia, 0.12 g/in³ of alumina, and 5 weight-% of Cu based on the weight of the Chabazite.

### Example 1 SCR Catalyst According to the Present Invention

The catalyst of Example 1 was prepared as the catalyst of Comparative Example 1, except that the H-Chabazite was replaced by a Fe-Chabazite (with Fe content: 0.6 wt.-%, calculated as Fe₂O₃, based on the weight of the Chabazite, a Dv50 of 1.548 micrometers, a SiO₂:Al₂O₃ of 15.7:1, a BET specific area of 590 m²/g and a micropore surface area ZSA of 570 m²/g) prepared according to Reference Example 4, that the alumina powder (Al₂O₃ 80 weight-% and SiO₂ 20 weight-%, having a BET specific surface area of 185 m²/g, a Dv50 of 6.3 micrometers, and a Dv90 of 16.3 micrometers) was replaced by a powder of a non-zeolitic oxidic material comprising Fe and Al (Fe₂O₃ 50 wt.-% and Al₂O₃ 50 wt.-%, the material having a BET specific surface area of 112.85 m²/g, a Dv50 of 9.6 micrometers, a Dv90 of 20.5 micrometers, a Dv99 of 28.2 micrometers) and that the amount of alumina+iron was calculated such that the amount of alumina+iron after calcination was 10 weight-% based on the weight of the Chabazite after calcination.

The final coating loading in the catalyst after calcinations was 2.4 g/in³, including about 2.0 g/in³ of Chabazite, 0.1 g/in³ of zirconia, 0.2 g/in³ of the non-zeolitic oxidic material, 0.6 weight-% of Fe, calculated as Fe₂O₃, based on the weight of the Chabazite and 5 weight-% of Cu, calculated as CuO, based on the weight of the Chabazite. The other ingredients were burned off and do not contribute to the final coating loading.

### Example 2 Testing the Performance of the Prepared Catalysts of Comparative Example 1 and of Example 1

The catalysts of Comparative Example 1 and Example 1 were aged hydrothermally in an oven with 10% H₂O and 20% O₂ in N₂ at 800° C. for 16 hours prior to be tested. Engine bench tests were done in steady state conditions, DeNOx activity as well as N₂O formation were measured. The results are displayed in FIGS. 1 and 2.

TABLE 1
Engine bench conditions

| | | NOx emission | |
|---|---|---|---|
| Temperature [° C.] | Volume flow [m³/h] | engine out [ppm] | NSR |
| 200 | 144 | 273 | 1.5 |
| 230 | 165 | 381 | 1.5 |
| 600 | 112 | 351 | 2 |
| 650 | 118 | 410 | 2 |

As may be taken from FIG. 1, the catalytic activity in term of NOx conversion is similar for both catalysts, namely it exhibits a good NOx conversion at low temperatures as well as at high temperatures ranging from about 80 to 100%. However, as may be taken from FIG. 2, while the results are similar at low temperatures (200 and 230° C.), the SCR catalyst of the present invention permits to decrease the N₂O formation of more than 50% compared to the catalyst of Comparative Example 1, while maintaining similar NOx conversions of about 90 to 98% at high temperatures, namely at 601 and 650° C.

Thus, the catalyst of the present invention which comprises iron combined with alumina in its coating permits to reduce drastically the N₂O formation while maintaining very good NOx conversion at high temperatures.

### Comparative Example 2 SCR on Filter (SCROF) Catalyst not According to the Present Invention

A CuO powder having a Dv50 of 1.1 micrometers and a Dv90 of 5.8 micrometers was added to water. The amount of CuO was calculated such that the total amount of copper in the coating after calcination was of 4.15 weight-%, calculated as CuO, based on the weight of the Chabazite. Sucrose was further added to the Cu mixture, the amount of sucrose was calculated such that it was 4.15 weight-% based on the weight of the Chabazite. Acetic acid was added to the obtained slurry. The amount of acetic acid was calculated such that it was 1.7 weight-% based on the weight of the Chabazite. The resulting slurry had a solid content of 5 weight-% based on the weight of said slurry. An aqueous zirconium acetate solution was added to the CuO-containing mixture forming a slurry. The amount of zirconium acetate was calculated such that the amount of zirconia in the coating, calculated as ZrO₂, was 20 weight-% based on the weight of the Chabazite. A H-Chabazite (Dv50 of 1.548 micrometers, a SiO₂:Al₂O₃ of 15.7:1, a BET specific surface area of 590 m²/g and a micropore surface area (ZSA) of 570 m²/g) was added to the copper containing slurry having a solid content of 37 weight-% based on the weight of said mixture. The resulting slurry was milled using a continuous milling apparatus so that the Dv99 value of the particles was of about 9 micrometers, the Dv90 value of the particles was of about 2.5 micrometers and the Dv50 value of the particles was of about 1.35 micrometers. An alumina powder (Al₂O₃ 100 weight-% having a BET specific surface area of 178 m²/g, a Dv50 of 2.6 micrometers, a Dv90 of about 5.3 micrometers and a Dv99 of about 8.5 micrometers) was added to the Cu/CHA containing slurry. The amount of alumina was calculated such that the amount of alumina+silica after calcination was 10 weight-% based on the weight of the Chabazite after calcination in the final catalyst. Water was added to the obtained mixture to obtain a mixture with a solid content of 37 wt.-% based on the weight of said mixture.

A porous uncoated wall-flow filter substrate, silicon carbide, (volume: 3.4 L, an average porosity of 59%, a mean pore size of 17.5 micrometers and 350 cpsi and 12 mil wall thickness, diameter: 6.43 inches x length: 6.39 inches) was coated twice with the obtained mixture in an optimized design where a 1^{st} coat covers 70% of the substrate length from the outlet end to the inlet end and a 2^{nd} coat from the inlet end to the outlet end also with 70% of the substrate length, forming a single coating extending along the entire length of the substrate. To do so, the substrate was dipped in the respective slurry starting from the outlet end until the slurry arrived at the 70% of the length of the substrate. After dipping from the outlet end, a pressure pulse was applied from the inlet end to blow out the excess slurry. Further, the substrate was dipped in the respective slurry starting from the inlet end until the slurry arrived at the 70% of the length of the substrate. After dipping from the inlet end, a pressure pulse was applied from the outlet end to blow out the excess slurry. Further, the coated substrate was dried at 140° C. for 30 min and calcined at 450° C. for 1 hours. The final coating loading in the catalyst after calcinations was 1.75 g/in³, including about 1.31 g/in³ of Chabazite, 0.26 g/in³ of zirconia, 0.13 g/in³ of alumina, and 4.15 weight-% of Cu based on the weight of the Chabazite.

### Example 3 SCR on Filter (SCROF) Catalyst According to the Present Invention

The catalyst of Example 3 was prepared as the catalyst of Comparative Example 2, except that the H-Chabazite was replaced by a Fe-Chabazite (with Fe content: 0.6 wt.-%, calculated as Fe₂O₃, based on the weight of the Chabazite, a Dv50 of 1.548 micrometers, a SiO₂:Al₂O₃ of 15.7:1, a BET specific area of 590 m²/g and a micropore surface area ZSA of 570 m²/g) prepared as described in Reference Example 4 and that the alumina powder (Al₂O₃ 100 weight-%) was replaced by a powder of a non-zeolitic oxidic material comprising Fe and Al (Fe₂O₃ 50 wt.-% and Al₂O₃ 50 wt.-%, the material having a Dv50 of 10.15 micrometers, a Dv90 of 100.13 micrometers).

The final coating loading in the catalyst after calcinations was 1.75 g/in³, including about 1.31 g/in³ of Chabazite, 0.26 g/in³ of zirconia, 0.13 g/in³ of the non-zeolitic oxidic material, 0.6 weight-% of Fe, calculated as Fe₂O₃, based on the weight of the Chabazite and 4.15 weight-% of Cu, calculated as CuO, based on the weight of the Chabazite. The other ingredients were burned off and do not contribute to the final coating loading.

### Comparative Example 3 SCR on Filter (SCROF) Catalyst not According to the Present Invention

### Outlet Slurry:

H-Chabazite (Dv50 of 1.548 micrometers, a SiO₂:Al₂O₃ of 15.7:1, a BET specific surface area of 590 m²/g and a micropore surface area (ZSA) of 570 m²/g) was Fe-impregnated (0.6 wt.-% Fe, calculated as Fe₂O₃, based on the weight of the Chabazite, source of Fe: Fe-(III)-Nitrate-9 hydrate). Separately, a CuO powder having a Dv50 of 1.1 micrometers and a Dv90 of 5.8 micrometers was added to water. The amount of CuO was calculated such that the total amount of copper in the coating after calcination was of 3.5 weight-%, calculated as CuO, based on the weight of the Chabazite. Sucrose was further added to the Cu mixture, the amount of sucrose was calculated such that it was 3.5 weight-% based on the weight of the Chabazite. Acetic acid was subsequently added to the obtained slurry. The amount of acetic acid was calculated such that it was 1.7 weight-% based on the weight of the Chabazite. The resulting slurry had a solid content of 5 weight-% based on the weight of said slurry. An aqueous zirconium acetate solution was added to the CuO-containing mixture forming a slurry. The amount of zirconium acetate was calculated such that the amount of zirconia in the coating, calculated as ZrO₂, was 20 weight-% based on the weight of the Chabazite. Further, the Fe-Chabazite previously obtained was added to water and mixed to the copper containing slurry. The resulting slurry was milled using a continuous milling apparatus so that the Dv99 value of the particles was of about 9 micrometers, the Dv90 value of the particles was of about 2.5 micrometers and the Dv50 value of the particles was of about 1.35 micrometers.

An alumina powder (Al₂O₃ 100 weight-% having a BET specific surface area of 178 m²/g, a Dv50 of 2.6 micrometers, a Dv90 of about 5.3 micrometers and a Dv99 of about 8.5 micrometers) was added to the Chabazite containing slurry. The amount of alumina was calculated such that the amount of alumina after calcination was 10 weight-% based on the weight of the Chabazite after calcination. Water was added to the obtained mixture to obtain a mixture with a solid content of 37 wt.-% based on the weight of said mixture.

### Inlet Slurry:

A Fe BEA zeolite (with an Fe amount of 6.5 weight-%, calculated as Fe₂O₃, based on the weight of BEA, a Dv50 of 2.1 micrometers, a SiO₂:Al₂O₃ of 9.6:1, a BET specific surface area of 476 m²/g) was dispersed with zirconia acetate. The amount of zirconium acetate was calculated such that the amount of zirconia in the coating, calculated as ZrO₂, was 20 weight-% based on the weight of the BEA zeolite. The resulting mixture was milled using a continuous milling apparatus so that the Dv99 value of the particles was of about 9 micrometers, the Dv90 value of the particles was of about 3 micrometers, and the Dv50 value of the particles was of about 1.5 micrometers. Further, an alumina powder (Al₂O₃ 100 weight-% having a BET specific surface area of 178 m²/g, a Dv50 of 2.6 micrometers, a Dv90 of about 5.3 micrometers and a Dv99 of about 8.5 micrometers) was added to the BEA containing slurry. The amount of alumina was calculated such that the amount of alumina after calcination was 10 weight-% based on the weight of BEA after calcination. Water was added to the obtained mixture to obtain a mixture with a solid content of 37 wt.-% based on the weight of said mixture.

A porous uncoated wall-flow filter substrate, silicon carbide, (volume: 3.4 L, an average porosity of 59%, a mean pore size of 17.5 micrometers and 350 cpsi and 12 mil wall thickness, diameter: 6.43 inches x length: 6.39 inches) was coated twice in an optimized design where a 1^{st} coat, using the outlet slurry, was applied from the outlet end to the inlet end over 80% of the substrate length followed by the application of a 2^{nd} coat, using the inlet slurry, from the inlet end to the outlet end also over 80% of the substrate length. To do so, the substrate was dipped in the respective slurry starting from the outlet end until the slurry arrived at the 80% of the length of the substrate. After dipping from the outlet end, a pressure pulse was applied from the inlet end to blow out the excess slurry. Further, the substrate was dipped in the respective slurry starting from the inlet end until the slurry arrived at the 80% of the length of the substrate. After dipping from the inlet end, a pressure pulse was applied from the outlet end to blow out the excess slurry. Further, the coated substrate was dried at 140° C. for 30 min and calcined at 450° C. for 1 hour.

The final coating loading in the catalyst after calcinations was 1.76 g/in³, including about 1.6 g/in³ of Chabazite based coat and 0.6 g/in³ Fe-BEA based.

### Example 4 Testing the Performance of the Prepared Catalysts of Comparative Examples 2 and 3 and of Example 3

The catalysts of Comparative Examples 2 and 3 and Example 3 were aged hydrothermally in an oven at 850° C. with high flow 25 L, 2.422 ml/min H₂O and 20% O₂ (rest N₂) for 16 hours prior to be tested. Engine bench tests were done in steady state conditions (Daimler-OM651, 2.2 L, 4Zyl. 150 KW), DeNOx activity as well as N₂O formation were measured. The results are displayed in FIGS. 3-6.

TABLE 2
Engine bench conditions

| | | NOx emission | |
|---|---|---|---|
| Temperature [° C.] | Volume flow [m³/h] | engine out [ppm] | NSR |
| 195 | 137 | 244 | 1.50 |
| 231 | 160 | 356 | 1.50 |
| 598 | 112 | 368 | 2.00 |
| 650 | 119 | 416 | 2.00 |

As may be taken from FIG. 3, the catalyst according to the present invention exhibits good NOx conversion at low temperatures as well as at high temperatures, namely of about 95% at 231° C., of 90% at 599° C., of about 75% at 650° C., which are quite similar to the NOx conversions obtained with the catalyst of Comparative Example 2. However, as may be taken from FIG. 4, the SCR catalyst of the present invention permits to decrease the N₂O formation of up to about 50% compared to the catalyst of Comparative Example 2 in a very broad temperature range from 195° C. to 650° C. Further, compared to the catalyst of Comp. Example 3, the catalyst of Example 2 according to the present invention presents the best compromise in terms of a balance between a good NOx conversion with acceptable N₂O formation. Indeed, while the catalyst of Example 2 exhibits improved NOx conversion of about 20-30% compared to those of the catalyst of Comp. Example 3, the N₂O formation of the catalyst of Example 2 is increased on only 0.5% compared to the catalyst of Comp. Example 3 at low temperatures. This is illustrated by FIGS. 5 and 6.

Thus, the catalyst of the present invention which comprises iron combined with alumina in its coating permits to reduce drastically the N₂O formation while maintaining very good NOx conversion at high temperatures.

### Comparative Example 4 SCR on Filter (SCROF) Catalyst not According to the Present Invention

The catalyst of Comparative Example 4 was prepared as the catalyst of Comparative Example 2, except that the H-CHA was replaced by Fe-CHA, with CHA having a Dv50 of 1.548 micrometers, a SiO₂:Al₂O₃ of 15.7:1, a BET specific area of 590 m²/g and a micropore surface area ZSA of 570 m²/g, a Fe content was 0.6 wt.-%, calculated as Fe₂O₃, based on the weight of the Chabazite, Fe-CHA was prepared according to Reference Example 4 herein. The final coating loading in the catalyst after calcinations was 1.75 g/in³, including about 1.31 g/in³ of Chabazite, 0.26 g/in³ of zirconia, 0.13 g/in³ of alumina, 0.6 weight-% of Fe, calculated as Fe₂O₃, based on the weight of the Chabazite and 4.15 weight-% of Cu, calculated as CuO, based on the weight of the Chabazite.

### Reference Example 5 Comparing Performances of Comparative Examples 2 and 4

The catalysts of Comparative Examples 2 and 4 were aged hydrothermally in an oven at 850° C. with high flow 25 L flow, 20% O₂, 2.422 ml/min H₂O (rest N₂) for 16 hours prior to be tested. Engine bench tests were done in steady state conditions (Daimler-OM651, 2.2 L, 4Zyl. 150 KW), DeNOx activity as well as N₂O formation were measured. The results are displayed in FIGS. 7-8.

TABLE 3
Engine bench conditions

| | | NOx emission | |
|---|---|---|---|
| Temperature [° C.] | Volume flow [m³/h] | engine out [ppm] | NSR |
| 200 | 133 | 269 | 1.5 |
| 230 | 152 | 334 | 1.5 |
| 350 | 159 | 303 | 1.2 |
| 600 | 106 | 373 | 2 |
| 650 | 114 | 419 | 2 |

As may be taken from FIG. 7, the NOx conversion performances of the two comparative examples are about the same. Further, as may be taken from FIG. 8, the nitrous oxide formation is reduced of up to more than 0.5% with the catalyst of Comparative Example 4 which uses a Cu/Fe-CHA (starting zeolite being Fe impregnated CHA) compared to the catalyst of Comparative Example 2 which uses Cu-CHA (starting zeolite being H-CHA). Hence, from said example, it can be deduced that using Fe/Cu-CHA in a catalyst permits to reduce nitrous oxide formation compared to when using Cu-CHA in such catalyst. The nitrous oxide formation obtained with the catalyst of Comparative Example 4 is however higher than the nitrous oxide formation obtained with the catalyst of Example 1 according to the present invention. Indeed, with the inventive catalyst, a clear reduction of nitrous oxide can be seen at low temperatures as well as at high temperatures for which the nitrous oxide is reduce by about 2% at 650° C. compared to Comparative Example 2.

Therefore, from the experimental section of the present invention, it has clearly been demonstrated that the catalyst according to the present invention which comprises iron combined with alumina in its coating permits to reduce drastically the N₂O formation while maintaining very good NOx conversion.

### Example 5 SCR on Filter (SCROF) Catalyst According to the Present Invention

The catalyst of Example 5 was prepared as the catalyst of Comparative Example 2, except
that the H-Chabazite was replaced by a H-Chabazite having a Dv50 of 1 micrometers, a SiO₂:Al ₂O₃ of 18:1, a BET specific area of 550 m²/g and a micropore surface area ZSA of 520 m²/g),
that the alumina powder (Al₂O₃ 80 weight-% and SiO₂ 20 weight-%, having a BET specific surface area of 185 m²/g, a Dv50 of 6.3 micrometers, and a Dv90 of 16.3 micrometers) was replaced by a powder of a non-zeolitic oxidic material comprising Fe and Al (Fe₂O₃ 50 wt.-% and Al₂O₃ 50 wt.-%, the material having a BET specific surface area of 112.85 m²/g, a Dv50 of 9.6 micrometers, a Dv90 of 20.5 micrometers, a Dv99 of 28.2 micrometers); and
that the porous uncoated wall-flow filter substrate, silicon carbide, having a volume: 3.4 L, an average porosity of 59%, a mean pore size of 17.5 micrometers and 350 cpsi and 12 mil wall thickness, diameter: 6.43 inches x length: 6.39 inches, was replaced by a porous uncoated wall-flow filter substrate, silicon carbide, having a volume: 0.428 L, an average porosity of 59%, a mean pore size of 17.5 micrometers and 350 cpsi and 12 mil wall thickness, diameter: 2.3 inches×length: 6.39 inches.

The final coating loading in the catalyst after calcinations was 1.97 g/in³, including about 1.469 g/in³ of Chabazite, 0.29 g/in³ of zirconia, 0.15 g/in³ of the non-zeolitic oxidic material comprising Fe and Al, and 4.15 weight-% of Cu, calculated as CuO, based on the weight of the Chabazite. The other ingredients were burned off and do not contribute to the final coating loading.

### Comparative Example 5 SCR on Filter (SCROF) Catalyst not According to the Present Invention

The catalyst of Comparative Example 5 was prepared as the catalyst of Comparative Example 2, except that the H-Chabazite was replaced by a H-Chabazite having a Dv50 of 1 micrometers, a SiO₂:Al₂O₃ of 18:1, a BET specific area of 550 m²/g and a micropore surface area ZSA of 520 m²/g), and that the porous uncoated wall-flow filter substrate, silicon carbide, having a volume: 3.4 L, an average porosity of 59%, a mean pore size of 17.5 micrometers and 350 cpsi and 12 mil wall thickness, diameter: 6.43 inches x length: 6.39 inches, was replaced by a porous uncoated wall-flow filter substrate, silicon carbide, having a volume: 0.428 L, an average porosity of 59%, a mean pore size of 17.5 micrometers and 350 cpsi and 12 mil wall thickness, diameter: 2.3 inches x length: 6.39 inches.

The final coating loading in the catalyst after calcinations was 1.97 g/in³, including about 1.469 g/in³ of Chabazite, 0.29 g/in³ of zirconia, 0.15 g/in³ of the non-zeolitic oxidic material comprising Fe and Al, and 4.15 weight-% of Cu, calculated as CuO, based on the weight of the Chabazite. The other ingredients were burned off and do not contribute to the final coating loading.

### Example 6 Testing the Performance of the Prepared Catalysts of Comparative Examples 5 and of Example 5

The catalysts of Comparative Example 5 and Example 5 were aged hydrothermally in an oven at 850° C. with 10% H₂O and 20% O₂ (rest N₂) for 16 hours prior to be tested. Engine bench tests were done in steady state conditions (Daimler-OM651, 2.2 L, 4Zyl. 150 KW). DeNOx activity as well as N₂O formation were measured. The results are displayed in FIGS. 9-10.

TABLE 4
Engine bench conditions

| | | NOx emission | |
|---|---|---|---|
| Temperature [° C.] | Volume flow [m³/h] | engine out [ppm] | NSR |
| 578 | 10 | 470 | 4 |
| 630 | 10 | 380 | 4 |

As may be taken from FIG. 9, the catalyst according to the present invention (Example 5) exhibits good NOx conversion at high temperatures, namely of about 95% at 578° C., of about 80% at 630° C., which are quite similar to the NOx conversions obtained with the catalyst of Comparative Example 5. However, as may be taken from FIG. 10, the SCR catalyst of the present invention permits to decrease the N₂O formation of more than 7% compared to the catalyst of Comparative Example 5 at 578° C. and of up to 16% at 630° C. Further, compared to the catalyst of Comp. Example 5, the catalyst of Example 5 according to the present invention presents the best compromise in terms of a balance between a good NOx conversion with acceptable N₂O formation.

Thus, the catalyst of the present invention which comprises iron combined with alumina in its coating permits to reduce drastically the N₂O formation while maintaining very good NOx conversion at high temperatures.

### BRIEF DESCRIPTION OF THE FIGURES

FIG. 1 shows the NOx conversion obtained for the catalysts of Example 1 and Comparative Example 1 at different temperatures.

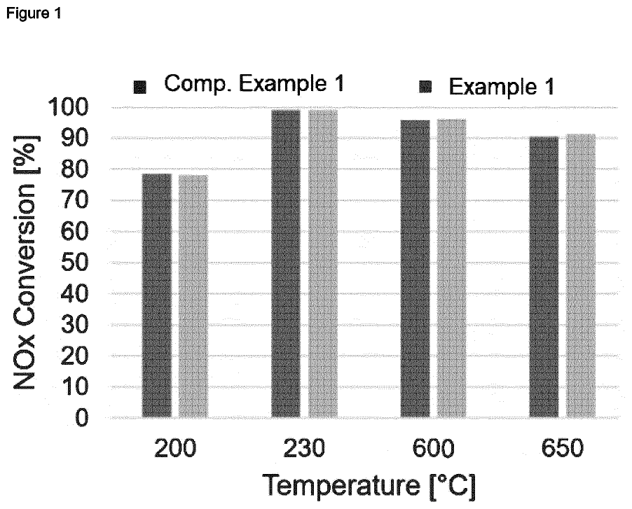

FIG. 2 shows the N₂O formed when using the catalysts of Example 1 and Comparative Example 1 at different temperatures. Relative N₂O is calculated according to the formula Relative N₂O [%]=N₂O [ppm]/(NOx engine out [ppm]*NOx Conversion [%]/100)*100

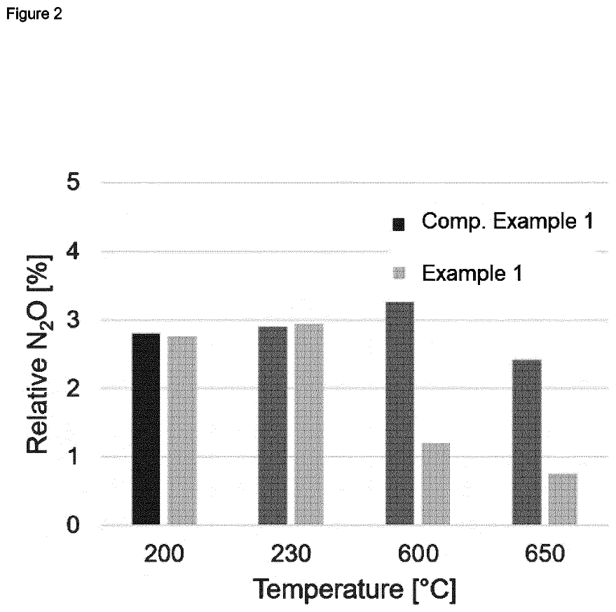

FIG. 3 shows the NOx conversion obtained for the catalysts of Example 3 and Comparative Example 2 over a wide temperature range (195 to 650° C.).

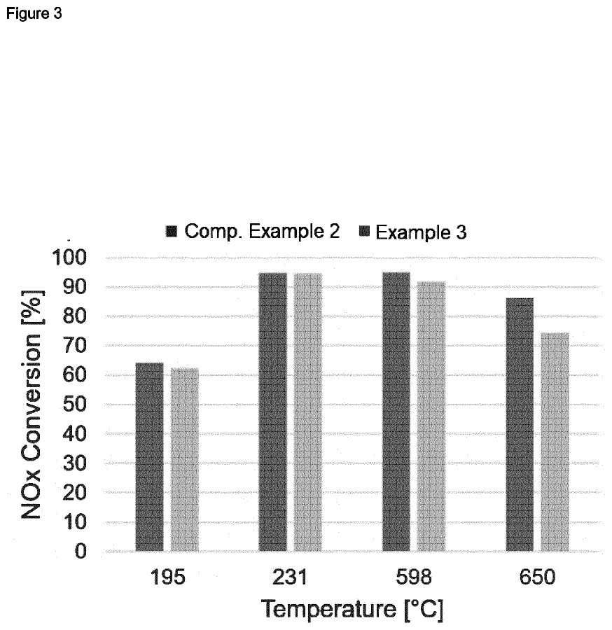

FIG. 4 shows the N₂O formed when using the catalysts of Example 3 and Comparative Example 2 over a wide temperature range (195 to 650° C.). Relative N₂O is calculated according to the formula Relative N₂O [%]=N₂O [ppm]/(NOx engine out [ppm]*NOx Conversion [%]/100)*100

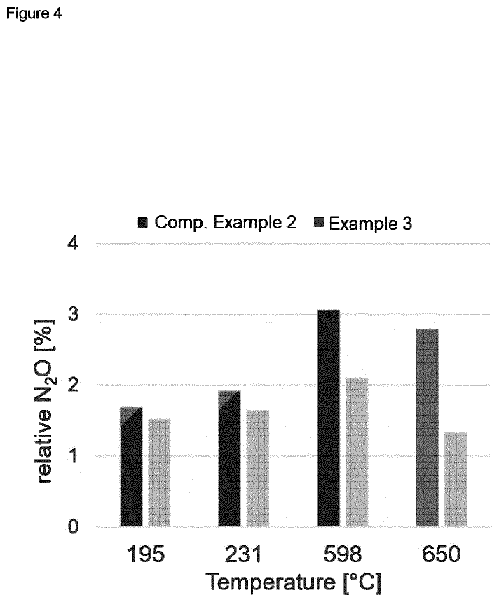

FIG. 5 shows the NOx conversion obtained for the catalysts of Example 3 and Comparative Examples 2 and 3 at low temperatures (198 and 231° C.).

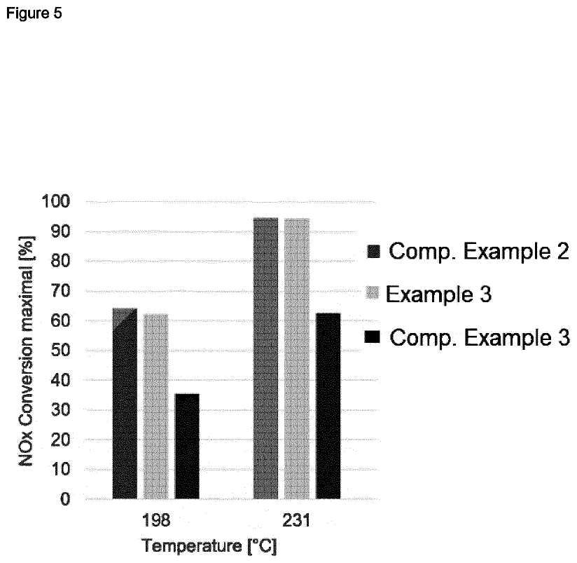

FIG. 6 shows the N₂O formed when using the catalysts of Example 3 and Comparative Examples 2 and 3 at low temperatures (198 and 231° C.). Relative N₂O is calculated according to the formula Relative N₂O [%]=N₂O [ppm]/(NOx engine out [ppm]*NOx Conversion [%]/100)*100

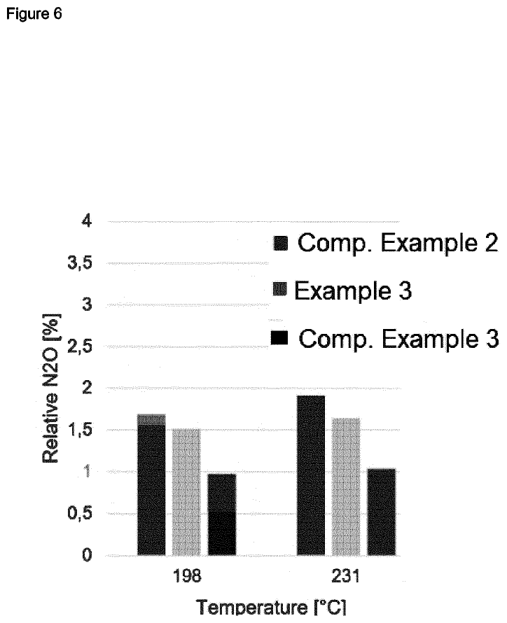

FIG. 7 shows the NOx conversion obtained for the catalysts of Comparative Examples 2 and 4.

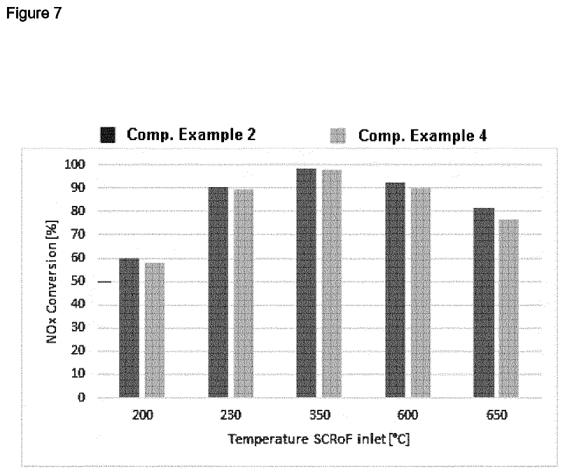

FIG. 8 shows the N₂O formed when using the catalysts of Comparative Examples 2 and 4. Relative N₂O is calculated according to the formula Relative N₂O [%]=N₂O [ppm]/(NOx engine out [ppm]*NOx Conversion [%]/100)*100

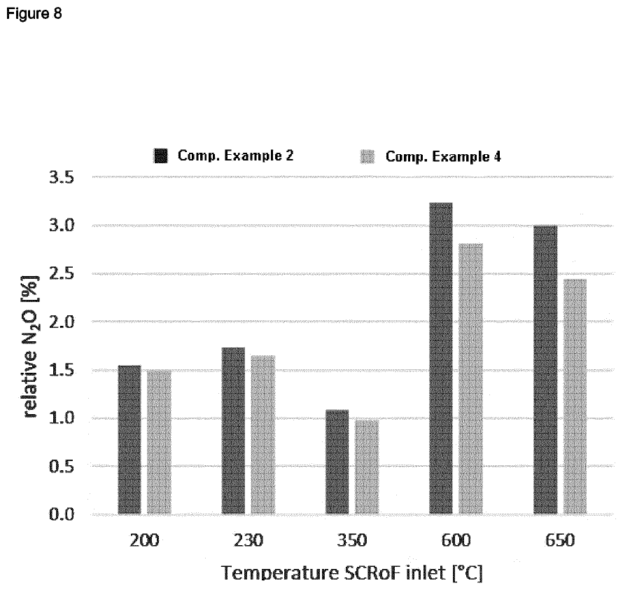

FIG. 9 shows the NOx conversion obtained for the catalysts of Comparative Example 5 and Example 5.

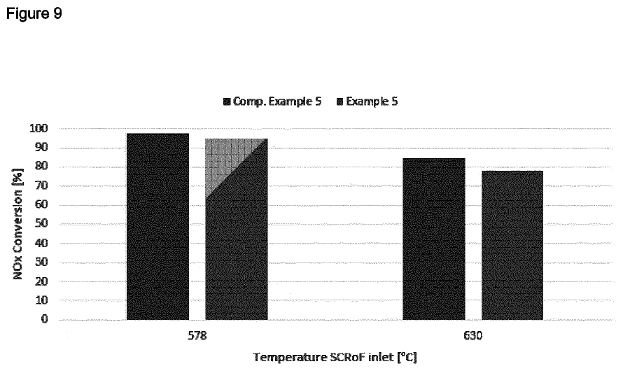

FIG. 10 shows the relative N₂O advantages formed when using the catalyst of Example 5 versus the catalyst of Comparative Example 5.

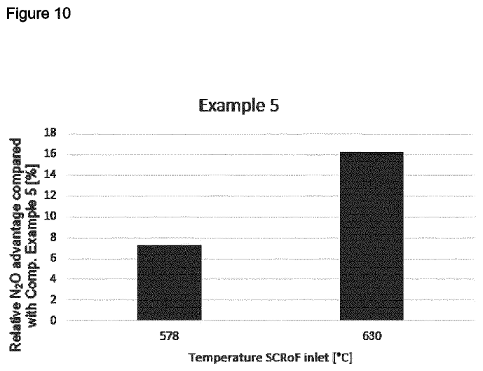

### CITED LITERATURE

U.S. Pat. No. 9,242,238 B2
U.S. Pat. No. 9,352,307 B2
U.S. Pat. No. 9,999,877 B2

1. A catalyst for the selective catalytic reduction of NOx comprising a substrate having an inlet end, an outlet end, a substrate axial length extending from the inlet end to the outlet end and a plurality of passages defined by internal walls of the sub-strate extending therethrough;
a coating comprising a zeolitic material, copper and a first non-zeolitic oxidic material comprising iron and aluminum, wherein at least 25 weight-% of the first non-zeolitic oxidic material consists of iron, calculated as Fe₂O₃.

2. The catalyst of claim 1, wherein the zeolitic material comprised in the coating has a framework type selected from the group consisting of CHA, AEI, RTH, LEV, DOR, KFI, ERi, AFX, a mixture of two or more thereof and a mixed type of two or more thereof, more preferably selected from the group consisting of CHA, AEI, RTH, AFX, a mixture of two or more thereof and a mixed type of two or more thereof, more preferably selected from the group consisting of CHA and AEI, wherein the zeolitic material comprised in the coating more preferably has a framework type CHA

3. The catalyst of claim 1, wherein the amount of copper comprised in the coating, cal-culated as CuO, is in the range of from 2 to 10 weight-%, preferably in the range of from 2.5 to 8 weight-%, more preferably in the range of from 3 to 7 weight-%, more preferably in the range of from 3.5 to 6 weight-%, based on the weight of the zeolitic material; where-in the zeolitic material comprised in the coating preferably comprises copper.

4. The catalyst of claim 1, wherein the zeolitic material comprises iron, wherein the amount of iron comprised in the zeolitic material, calculated as Fe₂O₃, is in the range of from 0.1 to 1.5 weight-%, preferably in the range of from 0.15 to 1.25 weight-%, more preferably in the range of from 0.25 to 1 weight-%, more preferably in the range of from 0.3 to 0.8 weight-%, based on the weight of the zeolitic material.

5. The catalyst of claim 1, wherein from 25 to 65 weight-%, preferably from 30 to 60 weight-%, more preferably from 40 to 55 weight-%, more preferably from 45 to 55 weight-%, of the first non-zeolitic oxidic material consists of iron, calculated as Fe₂O₃.

6. The catalyst of claim 1, wherein the coating comprises the first non-zeolitic oxidic material in an amount in the range of from 5 to 20 weight-%, preferably in the range of from 7 to 15 weight-%, more preferably in the range of from 8 to 12 weight-%, based on the weight of the zeolitic material.

7. The catalyst of claim 1, wherein from 99 to 100 weight-%, preferably from 99.5 to 100 weight-%, more preferably from 99.9 to 100 weight-%, of the first non-zeolitic oxidic material consist of Al, Fe and O.

8. The catalyst of claim 1, wherein, in the catalyst, the weight ratio of the zeolitic material relative to the first non-zeolitic oxidic material is in the range of from 4.6:1 to 10:1, more preferably in the range of from 6:1 to 9.3:1, more preferably in the range of from 7:1 to 8.75:1.

9. The catalyst of claim 1, wherein the coating further comprises a second non-zeolitic oxidic material, the second non-zeolitic oxidic material preferably comprises one or more of zirconia, alumina, titania, silica, and a mixed oxide comprising two or more of Zr, Al, Ti, and Si, more preferably comprises one or more of silica, alumina and zirco-nia, more preferably comprises one or more of alumina and zirconia, more preferably zirconia;
wherein preferably from 95 to 100 weight-%, more preferably from 98 to 100 weight-%, more preferably from 99 to 100 weight-%, more preferably from 99.5 to 100 weight-%, of the second non-zeolitic oxidic material comprised in the coating consists of zirconium, calculated as ZrO2.

10. A process for preparing a catalyst for the selective catalytic reduction of NOx, preferably the catalyst according to claim 1, the process comprising
(i) preparing a first aqueous mixture comprising water, a source of copper, and preferably a precursor of a second non-zeolitic oxidic component;
(ii) admixing the first aqueous mixture obtained according to (i) with water and a zeolitic material, wherein the zeolitic material is free of copper and wherein the zeolitic material optionally comprises iron, obtaining a second aqueous mixture;
(iii) admixing a first non-zeolitic oxidic material comprising Al and Fe to the second aqueous mixture prepared according to (ii), wherein at least 25 weight-% of the first non-zeolitic oxidic material consists of iron, calculated as Fe₂O₃, preferably adding water, obtaining a third aqueous mixture;
(iv) disposing the third aqueous mixture obtained according to (iii) on a substrate com-prising an inlet end, an outlet end, a substrate axial length extending from the inlet end to the outlet end and a plurality of passages defined by internal walls of the substrate extending therethrough; and optionally drying the substrate comprising said mixture;
(v) calcining the substrate obtained in (iv).

11. The process of claim 10, wherein (i) comprises
(i.1) preparing a mixture comprising water and the source of copper, the mixture preferably further comprising an acid, more preferably an organic acid, more preferably acetic acid;
(i.2) adding the precursor of the second non-zeolitic oxidic component to the mixture obtained according to (i.1), obtaining the first aqueous mixture.

12. The process of claim 11, wherein from 90 to 100 weight-%, preferably from 93 to 99 weight-%, more preferably from 96 to 99 weight-%, of the source of copper is present in the mixture prepared in (i.1) in non-dissolved state;
wherein the particles of copper in the mixture according to (i.1) preferably have a Dv90 in the range of from 0.1 to 15 micrometers, more preferably in the range of from 0.5 to 10 micrometers, more preferably in the range of from 1 to 8 micrometers, more preferably in the range of from 3 to 7 micrometers.

13. A catalyst for the selective catalytic reduction of NOx obtainable or obtained by a process according to claim 10.

14. An exhaust gas treatment system for treating exhaust gas exiting a compression ignition engine, preferably a diesel engine, said exhaust gas treatment system having an upstream end for introducing said exhaust gas stream into said exhaust gas treatment system, wherein said exhaust gas treatment system comprises a catalyst according to claim 1 and one or more of a diesel oxidation catalyst, a selective cat-alytic reduction catalyst, an ammonia oxidation catalyst, a NOx trap and a particulate filter.

15. The system of claim 14, comprising a diesel oxidation catalyst, wherein the catalyst ac-cording to claim 1 is located downstream of the diesel oxidation catalyst.
